(19) United States
(12) Patent Application Publication
(10) Pub. No.: US 2010/0229467 A1
(43) Pub. Date: Sep. 16, 2010

(54) PHYSICAL SECURITY BARRIER

(76) Inventors: Mark R. Perkins, Eaton Rapids, MI (US); Christopher J. Sipe, Noblesville, IN (US)

Correspondence Address: Woodard, Emhardt, Moriarty, McNett & Henry LLP, 111 Monument Circle, Suite 3700, Indianapolis, IN, 46204-5137, US

(21) Appl. No.: 12/393,619

(22) Filed: Feb. 26, 2009

(51) Int. Cl. E06B 7/28

(52) U.S. Cl. 49/9

(57) ABSTRACT

A crash barrier apparatus for a structure opening that is closable with a movable door, the door being constructed and arranged with a security structure to close off the structure opening. The specific security structure of the referenced crash barrier apparatus includes, in one embodiment, a first support that is anchored to a first base surface, a second support that is anchored to a second base surface, and a beam received by the supports. In other embodiments, cable arrangements are used.

### BACKGROUND OF THE INVENTION

The structural embodiments disclosed herein relate to high security overhead doors and physical security barriers for such overhead doors in the form of a crash barrier apparatus.

As background, it is acknowledged that blast resistant doors and windows currently exist and are used as part of structures defining interior and exterior environments. Some examples of intended use for blast resistant doors and windows include material storage rooms, laboratories, research facilities, nuclear power stations, ammunition depots, and military facilities.

The market currently provides for pedestrian doors, for example, which are ballistic, fire, or blast rated. However, the same protections do not extend to overhead doors which may be located within several feet of “rated and protected” pedestrian doors. These types of overhead doors, by design, are typically located at ground level and provide large vehicular entry or penetration points to the “envelope” of the building structure. At the present time, overhead door constructions do not exist that are rated for protection against ballistic penetration and blast impact. From a practical standpoint, the only possible way to make a ballistic or blast rated overhead door effective would be to K-Certify the door and, as a result, protect the overhead doors which are vulnerable from a vehicular attack. The U.S. military always requires DOS K-Rated and Certified barriers and there are no current or existing affordable solutions for protecting overhead door perimeter access points.

The typical overhead door types include roll-up, tilt-up, and sectional roll-up. Described briefly, a roll-up door is constructed from a “flexible” material or from a series of small interlocking panels that result in sufficient flexibility to roll up above the door opening on a large wheel device. A tilt-up door is a single panel that pivots out and up prior to being stowed. A sectional roll-up door is constructed of four or more sections (horizontal) that are hinged together and mounted on edge rollers. These edge rollers fit into tracks on each side of the opening such that the door is permitted to roll up and then back into its stowed position in the interior of the structure.

Although a wide variety of blast resistant doors and windows are currently offered by a number of manufacturers, very few physical security barriers are offered for overhead doors. One known construction for a blast-resistant overhead door uses heavy gauge steel cladding. The intent is to prevent access to the interior of the structure by way of the opening that is closed by the overhead door. The door may be defeated by a blast or could be defeated by driving a vehicle into the door.

The consideration of blast protection for an overhead door can be addressed at least in part by the construction of the door. While some of these measures may provide sufficient protection for a blast, the overall construction of the door and any associated physical security barriers, need to be able to withstand the crash force of an impacting vehicle. As already previewed, there is an entire body of ratings and specifications for crash tests and crash certifications for doors and thus for the physical security barriers used for such doors. A portion of the certification format is based on a specified vehicle having a design speed and weight. These values equate to a ramming force that the door and/or physical security barrier must withstand.

High security overhead door vehicular crash barriers function as critical infrastructure protection, act as explosives countermeasures, and blast mitigation and are important in securing entrances to buildings and building structures. Equipping an overhead door with a vehicular crash barrier structure would provide entrance security during elevated security alerts which may include high security inspection checkpoints and protecting buildings from planned destruction, such as the first World Trade Center terrorist attack. Traditional military-type automatic and manual barriers are utilized to provide perimeter protection and are designed for either first or second line defense, to establish explosion set-back points, and in some applications are used for access control. Unfortunately, most city structures, including older building designs and some new building designs, offer essentially no protection from a vehicle driving into the building through an opened or closed ground level overhead door. In city environments, explosion set-back points are impossible to establish. Simply consider the thousands of existing urban structures, the number of below ground parking lots and facilities, the design and construction of high rise offices and high rise buildings offering residential space, as well as the wide range of retail locations and warehouses. This variety of existing structures typically all have some type of ground level overhead door leading directly from the street or alley into the interior of the structure. The overhead door points of entry for such structures are often literally less than twenty (20) feet from the street. As a result, high security overhead door vehicular entrances should be engineered and utilized to minimize or eliminate vulnerabilities and risk. The physical security barrier in the form of a crash barrier apparatus, as disclosed herein, provides a novel and unobvious improvement to existing traditional overhead doors in terms of the overall security and protection strategies.

Each embodiment disclosed herein provides a physical security barrier that structurally interfaces and cooperates with an overhead door in a novel and unobvious manner.

### BRIEF SUMMARY

A crash barrier apparatus for a structure opening that is closable with a movable door, the door being constructed and arranged with a security structure to close off the structure opening. The specific security structure of the referenced crash barrier apparatus includes, in one embodiment, a first support that is anchored to a first base surface, a second support that is anchored to a second base surface, and a beam received by the supports. In other embodiments, cable arrangements are used.

One object of the present disclosure is to describe an improved crash barrier apparatus.

### BRIEF DESCRIPTION OF THE SEVERAL VIEWS OF THE DRAWINGS

FIG. 1 is a diagrammatic, perspective view of a crash barrier apparatus for a structure according to one embodiment.

FIG. 2 is a diagrammatic, perspective view of the FIG. 1 apparatus with a door of the structure in an open condition.

FIG. 3 is a diagrammatic, side elevational view of a door coil and operator for raising and lowering the door.

FIG. 4 is a diagrammatic, side elevational view of a beam and lift bracket arrangement that is part of the FIG. 1 apparatus.

FIG. 5 is a diagrammatic, side elevational view of an alternative beam and lift bracket arrangement.

FIG. 6 is a diagrammatic, side elevational view of the FIG. 5 arrangement in a second orientation.

FIG. 7 is a diagrammatic, front elevational view of crash barrier apparatus for a structure according to another embodiment.

FIG. 8 is a diagrammatic, partial, perspective view of a beam-capture support arrangement comprising a portion of the FIG. 7 apparatus.

FIG. 8A is a diagrammatic, partial, perspective view of a beam-capture support arrangement comprising a portion of the FIG. 7 apparatus.

FIG. 8B is a diagrammatic, partial perspective view of a beam-capture support arrangement comprising a portion of the FIG. 7 apparatus.

FIG. 9 is a diagrammatic, side elevational view of a cooperating bollard structure comprising a portion of the FIG. 7 apparatus.

FIG. 10 is a diagrammatic, side elevational view of an alternate cooperating bollard structure that is suitable for the FIG. 7 apparatus.

FIG. 11 is a diagrammatic, partial perspective view of a crash barrier apparatus for a structure according to another embodiment.

FIG. 11A is a diagrammatic, partial perspective view of an alternate cable arrangement that is suitable for the FIG. 11 apparatus.

FIG. 12 is a diagrammatic, perspective view of the FIG. 11 apparatus.

FIG. 13 is a diagrammatic, side elevational view of the FIG. 11 apparatus.

FIG. 14 is a diagrammatic, partial perspective view of an alternate double cable arrangement for the FIG. 11 apparatus.

FIG. 14A is a diagrammatic, partial perspective view of an alternate form of the FIG. 14 double cable arrangement.

FIG. 15 is a diagrammatic, perspective view of the FIG. 14 alternate arrangement.

FIG. 16 is a diagrammatic, side elevational view of the FIG. 14 alternate arrangement.

FIG. 17 is a diagrammatic, partial perspective view of a crash barrier apparatus for a structure according to another embodiment.

FIG. 17A is a diagrammatic, partial perspective view of an alternate cable arrangement that is suitable for the FIG. 17 apparatus.

FIG. 18 is a diagrammatic, perspective view of the FIG. 17 apparatus.

FIG. 19 is a diagrammatic, side elevational view of the FIG. 17 apparatus.

FIG. 20 is a diagrammatic, partial perspective view of an alternate double cable arrangement for the FIG. 17 apparatus.

FIG. 20A is a diagrammatic, partial perspective view of an alternate form of the FIG. 20 double cable arrangement.

FIG. 21 is a diagrammatic, perspective view of the FIG. 20 alternate arrangement.

FIG. 22 is a diagrammatic, side elevational view of the FIG. 20 alternate arrangement.

FIG. 23 is a diagrammatic, partial perspective view of a crash barrier apparatus for a structure according to another embodiment.

FIG. 24 is diagrammatic, side elevational view of the FIG. 23 apparatus.

FIG. 25 is a diagrammatic, partial perspective view of an alternate form of the FIG. 23 apparatus using reinforcing plates.

FIG. 26 is a diagrammatic, perspective view of a reinforcing plate with an optional strut sleeve.

FIG. 27 is a diagrammatic, partial perspective view of a cable and beam combination comprising a portion of the FIG. 23 apparatus.

FIG. 28 is a diagrammatic, partial perspective view of an alternate cable and beam combination that is suitable for the FIG. 23 apparatus.

FIG. 29 is a diagrammatic, partial perspective view of a crash barrier apparatus for a structure according to another embodiment.

FIG. 30 is a diagrammatic, side elevational view of the FIG. 29 apparatus.

FIG. 31 is a diagrammatic, perspective view of a crash barrier apparatus for a structure according to an other embodiment.

FIG. 32 is a diagrammatic, perspective view of the FIG. 31 apparatus, with a door of the structure in an open condition.

FIG. 33 is a diagrammatic, partial perspective view of a beam-to-beam joint comprising a portion of the FIG. 31 apparatus.

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

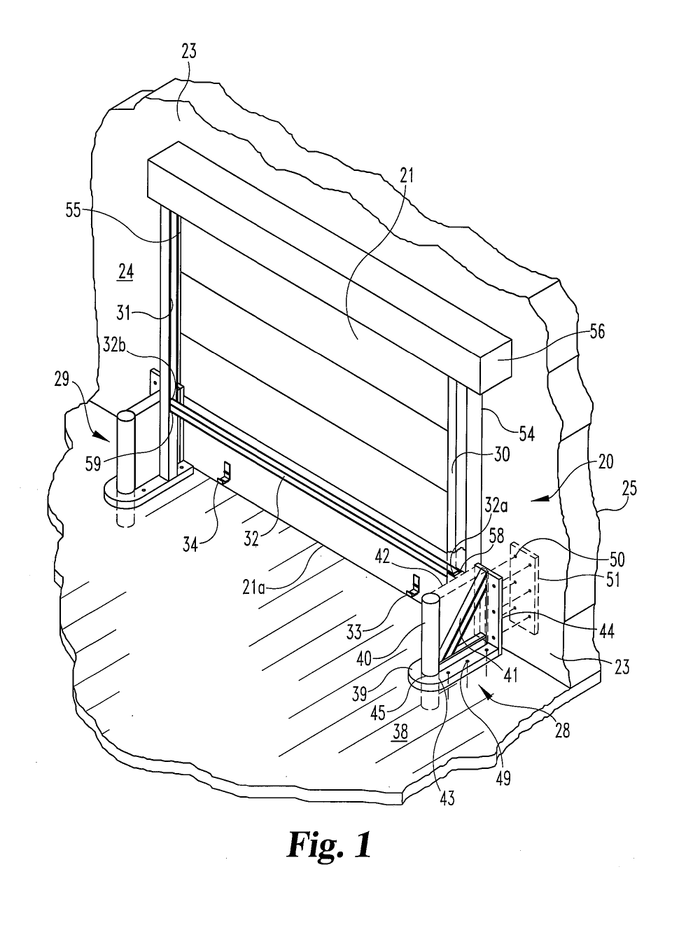

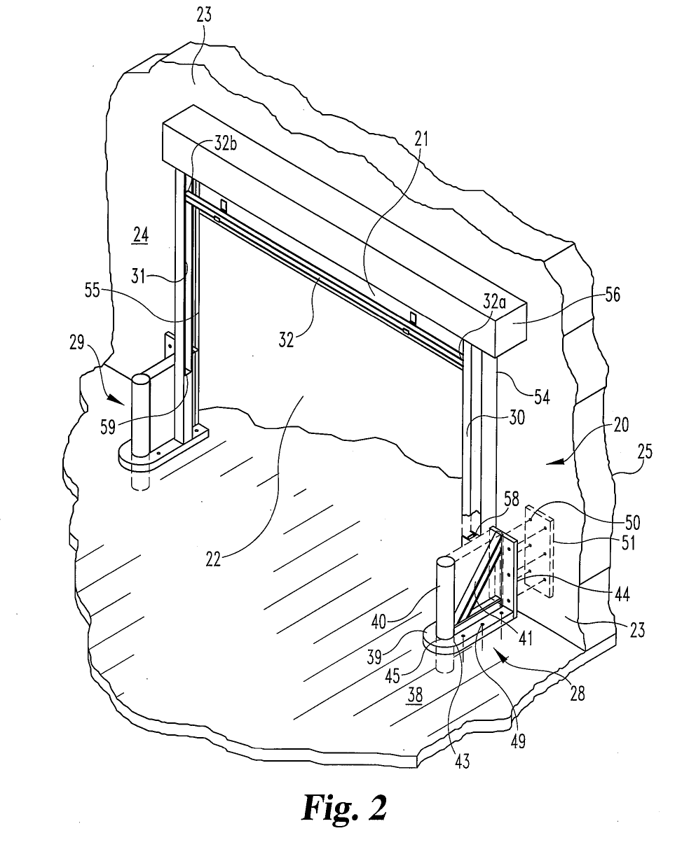

Referring to FIGS. 1-4, there is illustrated one embodiment of a physical security barrier arrangement according to the present disclosure that is exemplified by crash barrier apparatus 20. Crash barrier apparatus 20 is cooperatively arranged with overhead door 21. The diagrammatic illustrations of FIGS. 1-4 are intended to convey an understanding of the basic structure and operation of crash barrier 20. Overhead door 21 is constructed and arranged to close structure opening 22 in the normal or traditional manner, as would be well understood by those of ordinary skill in the art relative to overhead doors. The referenced structure that includes opening 22 can be virtually any building, laboratory, warehouse, etc. Use of the term “structure” is intended to generically cover any or all of these possibilities as well as others.

Only a portion of a wall 23 of the structure is illustrated. Wall 23 defines structure opening 22. The inner surface 24 of wall 23 is illustrated and is facing inwardly into the interior of the structure. The opposite side surface 25 (exterior) is outwardly facing to the outside atmosphere or in other arrangements, the interior of an outer surrounding interior space. Opening 22 is constructed and arranged to permit the passage therethrough of vehicles from the exterior of the structure into the interior of the structure.

While crash barrier apparatus 20 is constructed and arranged as a modification to an existing overhead door 21, apparatus 20 can also be constructed and arranged for new construction. Either approach incorporates the same basic group of component parts and attachment hardware. As such, apparatus 20 has design versatility and is suitable for new construction or modifications. As illustrated, apparatus 20 includes a first support 28, a second support 29, a first upright 30, a second upright 31, and a crash beam 32. Beam engagement members in the form of adjustable brackets 33 and 34 are attached to the door 21 adjacent the door lower edge 21a. Brackets 33 and 34 are constructed and arranged for moving into engagement with crash beam 32 as the door 21 is raised.

The first support 28 is constructed and arranged to be attached to stationary base 38 and to wall 23 on one side of opening 22. The second support 29 is also constructed and arranged to be attached to the stationary base 38 and to wall 23 on another (opposite) side of opening 22. The stationary base 38 is typically a concrete floor, slab, or base flooring or foundation of some type, whether on the interior of the structure or on the exterior of the structure. The overall arrangement and construction of each support 28 and 29 is substantially the same except for the expected right side and left side differences of each feature that are not symmetrical relative to or about a centerline. As such, a more detailed explanation of the construction of one support will suffice as the detailed explanation of the construction of the other support.

More specifically, first support 28 includes a base panel 39, a bollard 40, and a frame assembly 41. The illustrated embodiment includes an enclosure 42 covering the frame assembly 41. The base panel 39 includes a horizontal portion 43 and a vertical portion 44. In this disclosed embodiment, each portion 43 and 44 is a substantially flat steel plate. These two portions 43 and 44 are positioned so as to define a substantially right angle inside corner. Portion 44 is positioned at one end of portion 43. Portions 43 and 44 can be constructed and arranged as separate component parts that are securely attached to each other or these two portions can be parts of a unitary member, i.e., the base panel. A further option is to integrally join these two portions together by welding.

The bollard 40 is constructed and arranged as a generally cylindrical post and is positioned as part of support 28 in a vertically-upright orientation. A lower portion of bollard 40 extends into base 38 and is anchored into base 38, typically by a concrete footing. A clearance hole 45 in portion 43 allows the bollard to extend above base 38, as is illustrated. Preferably each clearance hole 45 through portion 43 and each corresponding bollard 40 have a close dimensional fit. Bollard 40 is preferably concrete filled, but other constructions and materials are contemplated.

Portion 43 is securely anchored into base 38 and portion 44 is securely attached or anchored to wall 23. The frame assembly is securely attached to portion 43, to bollard 40, and to portion 44. The anchoring of portion 43 to base 38 is achieved by the use of threaded fasteners 49. When base 38 is concrete, these threaded fasteners are concrete anchors 49. The illustrated anchoring of portion 44 to wall 23 assumes that structure wall 23 is fabricated out of concrete or concrete blocks. One option or arrangement is to use threaded fasteners 50 with a back-up or reinforcing steel plate 51 positioned on the opposite (outer) side of wall 23 relative to and cooperating with portion 44. As previously explained, the construction of second support 29 is essentially the same as what has been described for first support 28.

It is to be understood that the construction and arrangement of supports 28 and 29, as illustrated in FIGS. 1-3, is representative of one embodiment and several other embodiments are contemplated and disclosed. One point to be made is that the overall strength and rigidity of each support 28 and 29 is important. The selected approach, as disclosed herein, is to have a structural arrangement on each side of the structure opening 22. Each such arrangement is constructed and arranged with an interior portion one side of wall 23 and a cooperating exterior portion on the other (opposite) side of wall 23. Anchoring members or struts extend through wall 23 and connect the interior portion of each arrangement with the exterior portion of each arrangement. One or both of the interior and exterior portions of each structural arrangement are securely anchored to and/or into base 38. Although the embodiment of FIGS. 1-3 uses a reinforcement plate 51 on the outside of wall 23, the threaded fasteners constitute the referenced anchoring members and a lower portion of bollard 40 extends down into base 38. Although concrete anchors are one option for securing bollard 40 to or into base 38, another option is to use a poured concrete footing and insert a lower portion of the bollard directly into that footing. In other embodiments, as disclosed herein, an exterior bollard, anchored into the exterior base, is used in combination with the interior bollard. This combination is repeated for each structural arrangement. For a single bay opening, this means a total of four bollards being used, two on the interior of the structure and two on the exterior of the structure. In essence, there is one bollard at each corner of the opening.

The referenced strength and rigidity of each structural arrangement, such as supports 28 and 29, is important since the interior portions of each are used to receive or capture a portion of a barrier component or structure, such as beam 32, in order to barricade opening 22 from complete ingress into the structure by a vehicle. In terms of the degree or extent of vehicle ingress into the interior space of the structure, the applicable specifications for barrier systems of this type are written to as to define not only the vehicle, the vehicle weight and speed, but also to define how far into the interior space a particular reference point on that vehicle is allowed to penetrate if the barrier system is going to meet the required specification. If the barrier system restricts vehicle ingress to a point that is within the specified distance or limit, then the barrier system meets the specification for that particular vehicle, vehicle weight and speed.

Since the overhead door provides very little resistance to a high-weight vehicle (typically a truck) traveling at 30-50 miles per hour toward the opening 22, the beam 32, in cooperation with the first and second supports 28 and 29, is expected to provide virtually all of the barrier resistance. As the front of the vehicle pushes through door 21 or at least pushes door 21 into beam 32, the beam 32 begins to deflect under the load. As the beam 32 deflect, its free ends 32a and 32b begin to try and pull away or pull free from the captured state within the first and second supports 28 and 29, respectively. This places a load on each support and there is a load on the anchoring of each support 28 and 29 into the ground, floor, or base. The stronger each support and the stronger the capture of the beam ends by each support, the greater the resistance of the barrier beam 32. These aspects are important to the overall strength, since there are numerous options for strengthening or reinforcing the beam, including other barrier configurations such as those using cable arrangements, as disclosed herein.

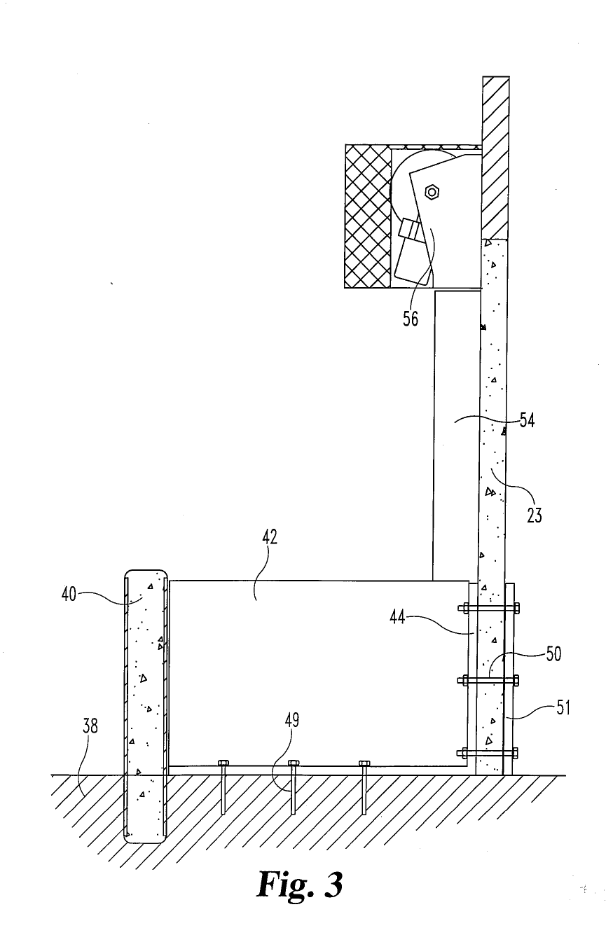

With continued reference to FIGS. 1-4, the crash barrier apparatus 20 cooperates with the wall 23, opening 22, and door 21 and with a pair of opposite-disposed side channels 54 and 55, constructed as part of the door frame and an overhead door coil and operator 56 (see FIG. 3). Whatever guide or roller structure is selected for raising and lowering movement of the door 21, the roller structure would typically travel in these two side channels 54 and 55. Depending on the particular style of door, the coil portion of the coil and operator 56 may be replaced or modified with additional frame and channel portions in order to accommodate the receipt of the door 21 into a stowed position above the opening 22.

First upright 30 is securely attached to first support 28 and to a portion of the overhead door framework. Second upright 31 is securely attached to second support 29 and to another portion of the overhead door framework. Each upright 30 and 31 has the shape of a U-shaped channel with the opening side of each channel facing laterally inwardly toward each other, though on opposite sides of opening 22. Positioned within each upright 30 and 31 is a generally horizontal abutment block 58 and 59, respectively, that is constructed and arranged and positioned so as to receive a corresponding end 32a and 32b of beam 32. Beam end 32a fits within upright channel 30 and initially rests on block 58. Beam end 32b fits within upright channel 31 and initially rests on block 59. This initial positioning of beam 32 places the beam in a generally horizontal orientation closely adjacent to the inner surface of door 21 and extending completely across opening 22.

Each upright channel 30 and 31 is a thick-walled member with a channel depth of several inches so as to capture a significant portion of each beam end 32a and 32b. In this way, the upright channels 30 and 31 are not expected to bend or deflect to any degree or extent that might permit either end of beam 32 to become dislodged, at least not until the vehicle is essentially stopped. The upright channels 30 and 31 are not expected to fail by fracture or breakage and part of the upright channel strength is based in part on the strength and rigidity of the first and second supports 28 and 29.

When it is intended to raise the overhead door 21 so as to permit access to the interior of the structure under normal conditions, the beam 32 must be lifted out of the way or otherwise removed. In the exemplary embodiment of FIGS. 1-4, the opening process begins with energizing or activation of the door coil and operator 56. As the door 21 begins to be raised by the door lift mechanism, the lower edge 21a is lifted off of the ground or base 38 surface. Brackets 33 and 34 are securely attached to door 21 adjacent edge 21a and, as the door 21 is raised, these two brackets move upwardly in the direction of beam 32.

The adjustable nature of each bracket 33 and 34 allows the channel depth to be set to be larger than the thickness or depth of beam 32. The construction of each bracket 33 and 34 includes a rear L-bracket 63 and a front L-bracket 64. Rear L-bracket 63 is securely bolted directly to the door 21. The front L-bracket 64 is bolted to the rear L-bracket 63 with a slotted receiving hole for the described adjustability and depth.

Each bracket 33 and 34 is open at its top and this open end is deep enough to receive beam 32 as the door is raised. The interior bottom surface or base of each bracket is horizontally aligned with the other. The bottom surface or base of each bracket 33 and 34 contacts the lower surface of beam 32 at generally the same time, causing the beam to be received in the brackets and to move upwardly as the door 21 is raised. The ends of the beam 32 continue to travel in the channels of the corresponding uprights 30 and 31. When the door 21 is fully raised, such that the opening 22 is fully opened, the door motion is stopped and in this condition the brackets 33 and 34 are located adjacent the upper edge of the opening. As is well known in the art of overhead doors, optical switches, proximity switches, and trip levers can be used to control and stop the movement of the door. The beam 32 remains received in the brackets and retained adjacent that upper edge until the door 21 is lowered. In this way the beam 32 is automatically moved out of a blocking, security configuration across opening 22 when it is intended to raise the door 21 for authorized access into the structure or building.

When the door is to be closed over the opening 22, this action starts by energizing the drive motor, coil, or similar mechanism for lowering the door 21. As the door moves downwardly, the two brackets 33 and 34 move and, simply by gravity, the beam 32 is lowered, following and resting in the two brackets. This action continues with the ends of the beam being received in the upright channels 30 and 31, until the corresponding abutment blocks 58 and 59 are contacted by the ends. This action reseats and repositions the beam into a security barrier configuration. The door 21 continues to lower until the lower sensor is tripped, stopping the movement of the door with lower edge 21a positioned against or closely adjacent the base 38.

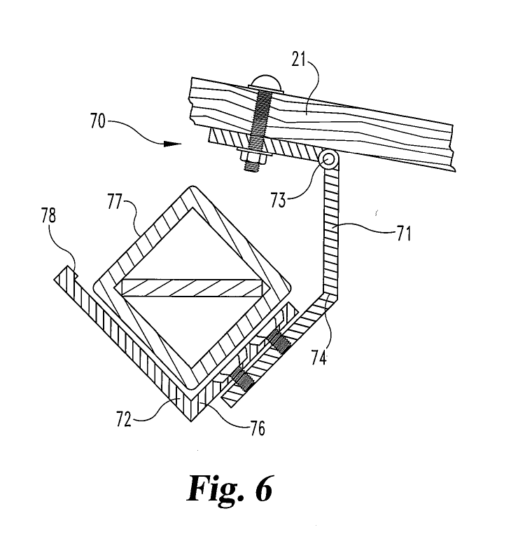

Referring now to FIGS. 5 and 6, another embodiment for the construction and arrangement of the beam and door brackets is disclosed. Bracket 70 is representative of the two brackets to be used and is a two-part construction including rear potion 71 and front portion 72. Rear portion 71 is hinged at pivot 73 and includes bend 74. Section 75 is attached to the door 21 and section 76 is attached to front portion 72 so as to create the V-shaped channel. This style of bracket is used when the beam 77 has a corresponding V-shape on its lower facing surface. This V-shape is also created when a generally square beam is turned about its longitudinal axis forty-five degrees.

While brackets 70 function relative to beam 77 in substantially the same way as brackets 33 and 34 function relative to the beam 32, the hinge construction results in a slightly different beam capture or receipt effect when the door is fully raised. As the door moves into a horizontal stowed position overhead, the bracket 70 pivots, as is illustrated in FIG. 6, in order to keep the beam 77 fully supported and captured. Brackets 33 and 34 have a square construction and the base or bottom surface of each bracket channel needs to stay in a generally horizontal orientation in order to capture and retain the beam.

If the raised door is stowed in a generally horizontal orientation, then the planar surface that constitutes the bracket-to-door interface turns from a vertical orientation to a horizontal orientation. Accordingly, brackets 33 and 34 are preferably used when the overhead door is coiled such that the base surface of each bracket channel stays in a generally horizontal orientation when the door is stowed overhead in a generally horizontal orientation. As the door is lowered, the beam 77 should follow the brackets 70, especially when the beam begins its downward vertical travel. Any required horizontal travel from the stowed position is assisted by lip 78 on the front edge of front portion 72.

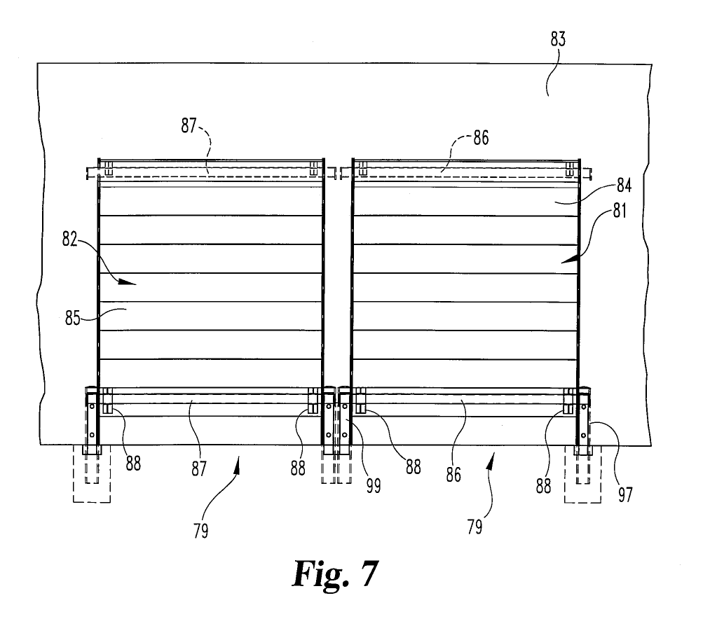

Referring now to FIGS. 7-10, there is illustrated another embodiment in the form of apparatus 79 and the focus of these four drawing figures is directed to the three primary structural features, beginning first with the use of security barrier beams for a pair of side-by-side structure openings that are each closed with an overhead door. The second feature is the direct connection of each beam to the pair of brackets. The third feature is the use of an exterior bollard and the use of generally horizontal, generally cylindrical struts that extend through the wall of the structure and connect to both an interior bollard and to an exterior bollard. With continued reference to FIGS. 7-10, these features are illustrated and described as follows.

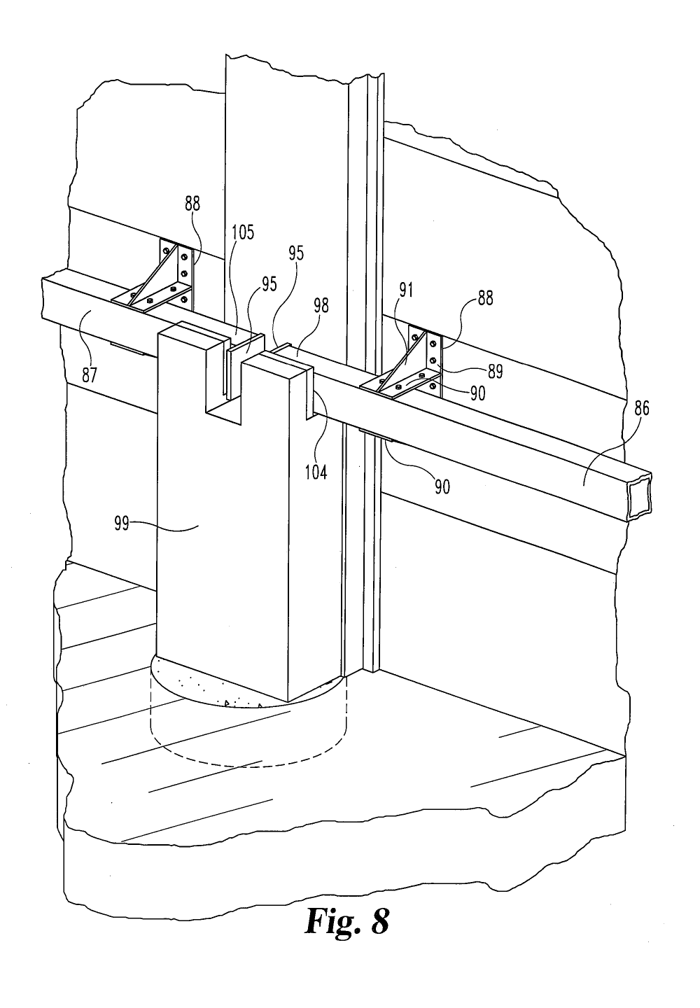

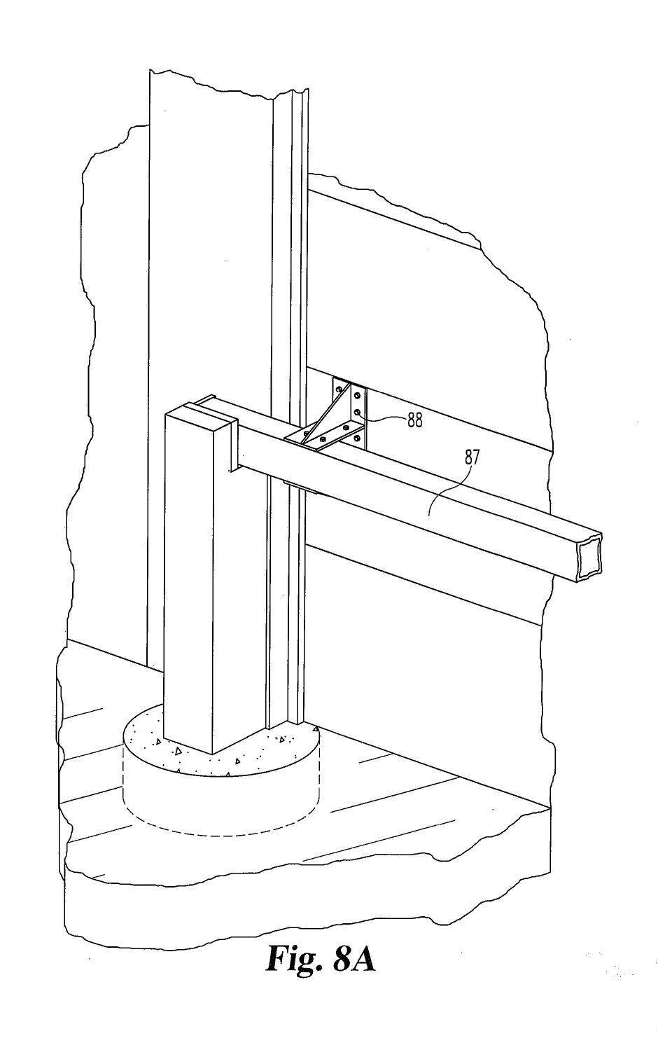

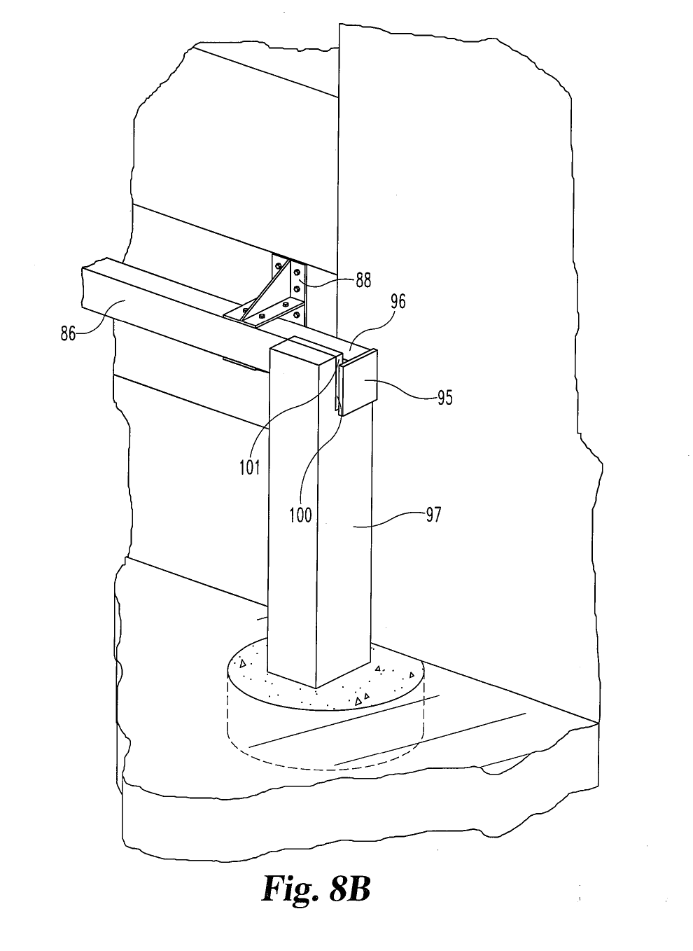

In FIG. 7, there is diagrammatically illustrated a pair of side-by-side structure openings 81 and 82 defined by structure wall 83 and closed by similar overhead doors 84 and 85, respectively. Attached to each door as a portion of each apparatus 79 is a corresponding security barrier beam 86 and 87. This physical connection is achieved by attaching a pair of horizontally aligned mounting brackets 88 directly to each door and then attaching the beam directly to each bracket (see FIGS. 7, 8, 8A, and 8B). Each bracket 88 is preferably a weldment that includes a base plate 89, a pair of spaced-apart beam plates 90, and a pair of connecting gussets 91. One gusset 91 is above beam 86 and the other gusset (not visible in FIG. 8) is below beam 86. Threaded fasteners are used for securely attaching base plate 89 to the door 21 and for securely attaching each beam plate 90 to the beam. The beams 86 and 87 are each generally square members and since they are securely attached to the door, the style, shape, and orientation is not a factor in terms of the style of door or how or where the door is stowed when raised to open the structure openings 81 and 82.

The end of each beam 86 and 87 is received in a support structure and for the following description, beam 86 is used, noting that the description for beam 87 is essentially the same except for the left versus right differences. Beam 86 has a generally square lateral section and a securely welded arresting plate 95 forming a L-configuration at the end of the beam. As viewed from the interior of the structure, the right end 96 of beam 86 is received by support structure 97. The left end 98 of beam 86 is received by support structure 99. Support structure 97 includes a channel 100 having defined length, width (depth) and height dimensions. The length dimension extends in the direction of the beam length. The width dimension extends in a direction generally perpendicular to the door and is wider than the width dimension of the beam. The height of the channel 100 is generally parallel to the surface of the door and is higher than the height of the beam. The arresting plate 95 extends away from the door and overlaps front wall 101 that helps to define channel 100.

Support structure 99 is configured similar to support structure 97 relative to the capture of beam end 98 in channel 104. Channel 104 is sized and shaped essentially the same as channel 100 and the right and left beam ends 96 and 98 are virtually the same, including the arrangement and use of arresting plates 95. However, overall support structure 97 and support structure 99 are different. Support structure 97 is a “single” and support structure 99 is a “double”. As illustrated in FIG. 8, support structure 99 is a single member that is constructed and arranged to receive the left end 98 of beam 86 and the right end 105 of beam 87. While the two channel constructions of support structure 99 are virtually identical, and are virtually identical to channel 100, there is some structural efficiency by combining the anchoring and overall support for two beam ends into the one unit represented by support structure 99.

When the door is raised, the beam 86 is pulled upwardly, extracting the ends 96 and 98 out of support structures 97 and 99, respectively. The beam 86 remains securely attached to the door, regardless of the style of door and regardless of the stowing arrangement and location. The position of the beams 86 and 87 when the doors are raised is illustrated in broken line form in FIG. 7. When the door is lowered, the beam 86 is carried with the door and is reinserted into the support structures 97 and 99. The same structures and methods are provided by the beam, bracket, and support structures associated with opening 82, door 85, and beam 87.

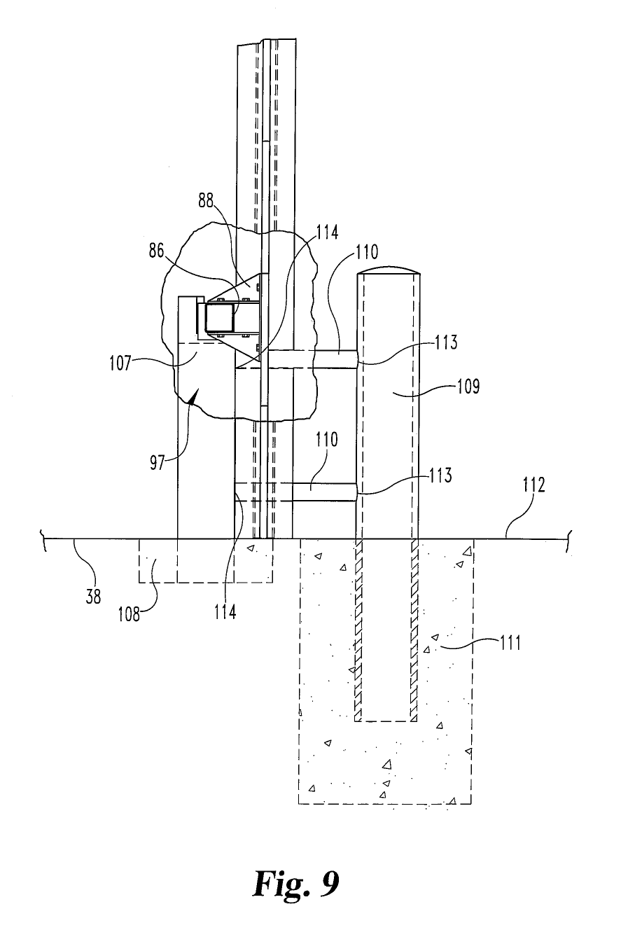

Referring now to FIG. 9, the details of support structure 97 are diagrammatically illustrated. Included as part of support structure 97 is an interior upright support post 107 (replaceable with an interior bollard or similar structure) with an interior footing 108 anchored down into base 38, an exterior bollard 109, and a pair of generally horizontal struts 110. The exterior bollard 109 is concrete filled and anchored down into an exterior footing 111 that is buried below exterior surface 112. The generally horizontal struts 110 are generally cylindrical rods with one end 113 of each anchored into bollard 109. The opposite end 114 of each strut is anchored into support post 107.

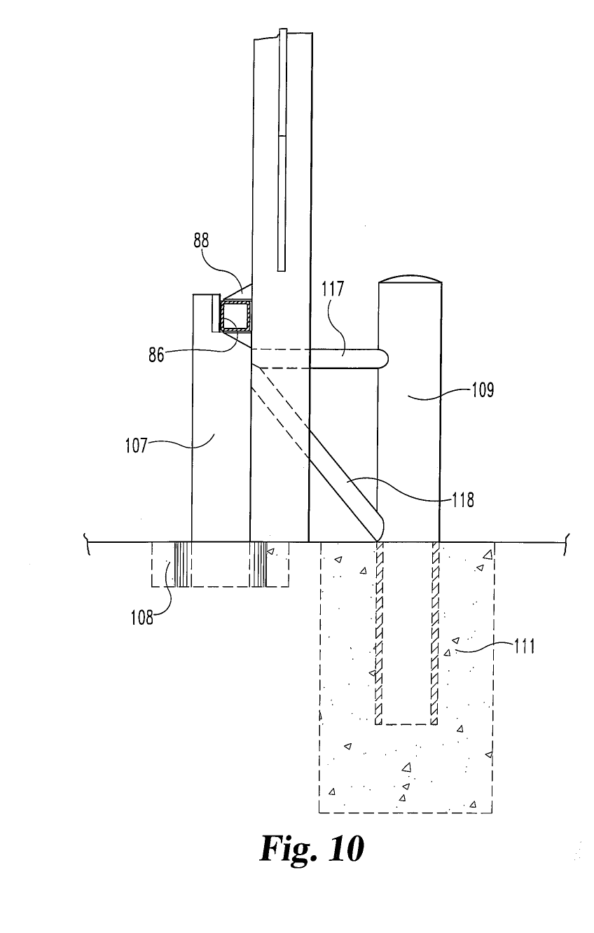

With reference to FIG. 10, an alternative embodiment is illustrated relative to the configuration of the struts. In the FIG. 9 arrangement, the two struts 110 extend through the structure wall in a generally horizontal orientation. In FIG. 10, one strut 117 is generally horizontal and the other strut 118 is set at an approximate forty-five degree angle.

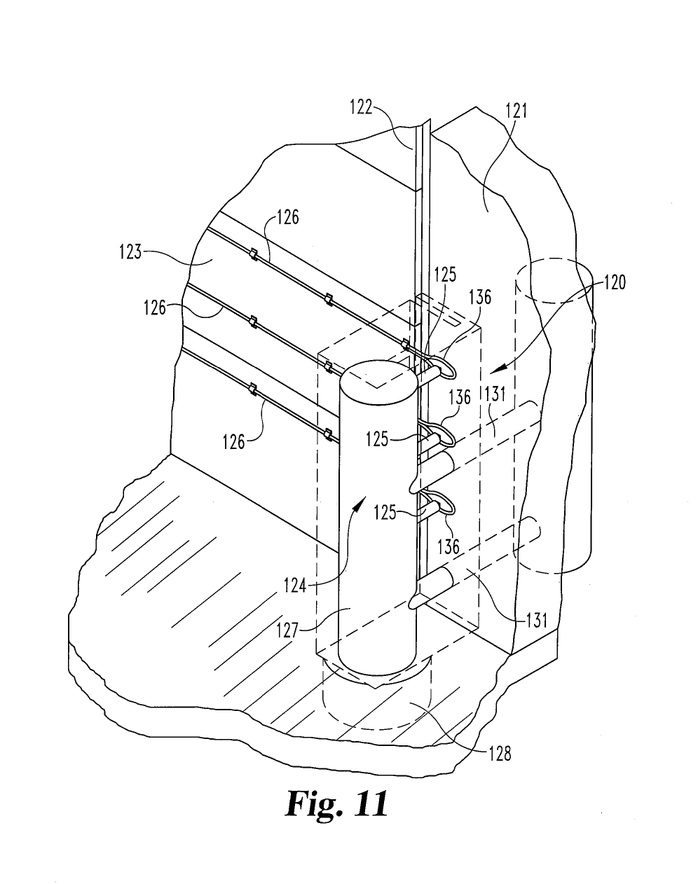

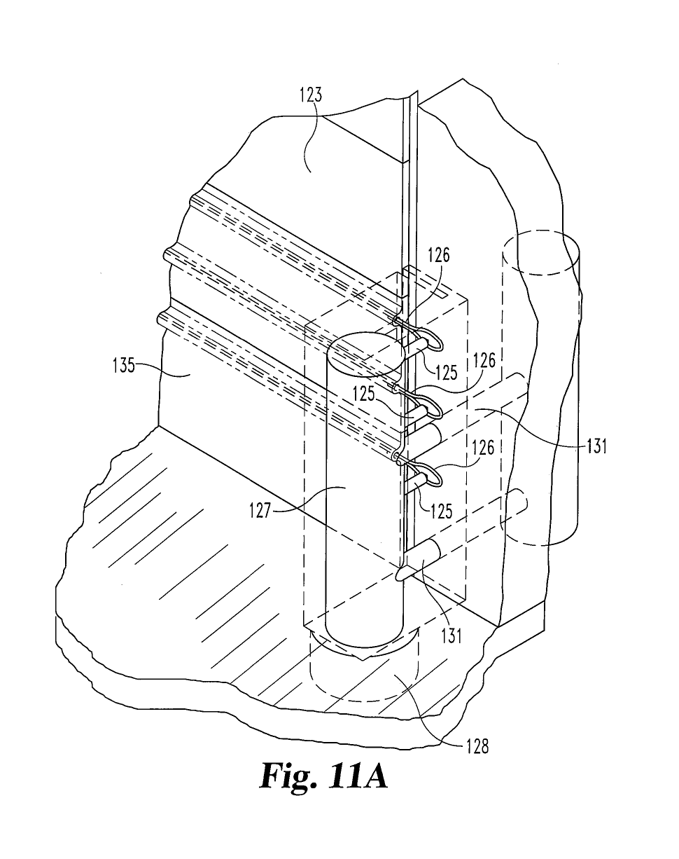

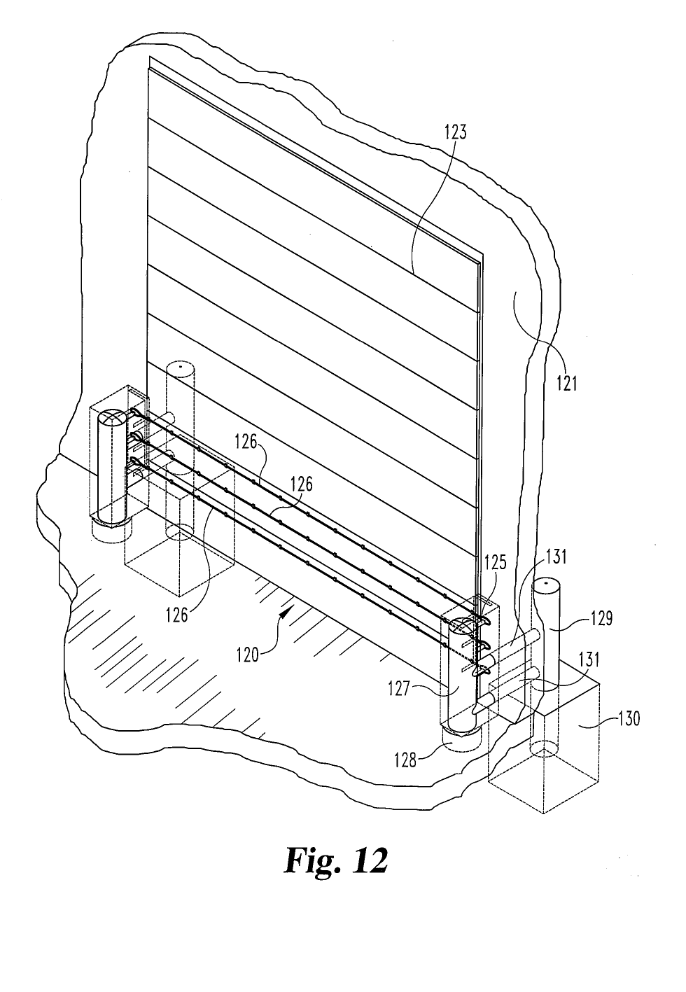

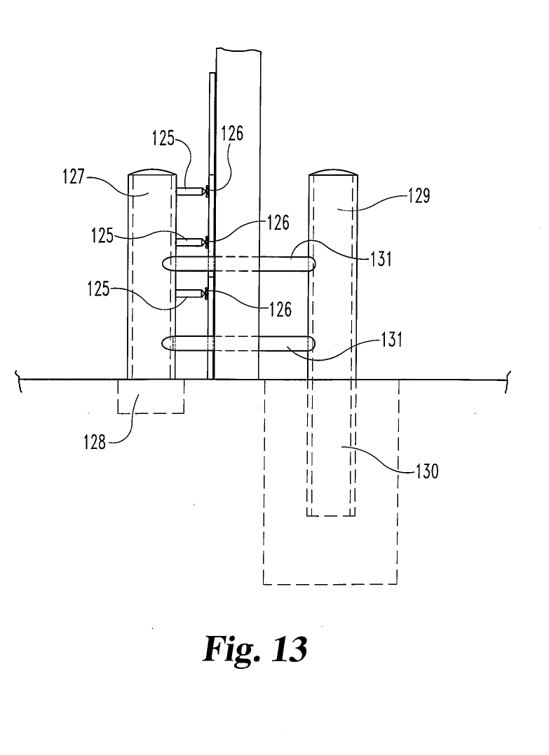

With reference to FIGS. 11-13, another embodiment is illustrated. Apparatus 120 is incorporated into a structure, a wall 121 of which is illustrated and defines opening 122. The opening 122 is closed by overhead door 123. The apparatus 120, opening 122, and door 123 are all singles, but the side-by-side arrangement of FIG. 7 could be practiced using apparatus 120 by simply putting a pair of arrangements side-by-side with a dual support structure positioned in between the two structure openings 122.

Support structure 124, as illustrated in FIG. 11, is constructed and arranged, in some respects, similar to support structure 97 in terms of having an upright support post and/or bollard, the footings, and the struts that extend through wall 121. One difference between support structures 97 and support structure 124 is the change from a structure to capture an end of the security barrier beam to a series of posts 125. These posts 125 cooperate with cables 126. Another difference is the change from one style of upright support to a bollard.

The support structure 124 includes an interior bollard 127 with a secure and rigid footing 128. An exterior bollard 129 cooperates with and is anchored by footing 130. There are two generally cylindrical struts 131 and each strut extends through wall 121 and is rigidly connected at one end to bollard 127 and at the opposite end to bollard 129. Each strut 131 has a generally horizontal orientation. One addition for the operation and functioning of apparatus 120 is the plurality of posts 125 and the use of cables 126.

As illustrated as part of apparatus 120, the beam of earlier embodiments is replaced with cables 126. These cables 126 are securely attached directly to the inner surface of door 123. Various threaded fasteners, clips, and/or cable clamps or ties are suitable for this attachment. Each end of each cable 126 is formed into a closed loop 136 and, in the initial or unloaded condition, each loop 136 is aligned with, but still spaced-part from, the free end of its corresponding post 125, as illustrated. The cables 126 are fabricated out of stranded wire rope as one option or out of a composite/synthetic material as another option.

When a vehicle attempts to break through the closed door in order to try and gain access into the structure by way of opening 122, the door initially deflects and this initial deflection introduces some degree of bow into the cables. This action then pulls the loops 136 onto the corresponding posts 125, thereby securing the ends of the cables to stationary support structures. This then tensions the cables to limit the further advance of the vehicle. One alternative embodiment (see FIG. 11A) to what is illustrated in FIGS. 11, 12, and 13 is to embed at least a portion of each cable 126 directly into the door 123 rather than attaching the cables 126 to the inner surface 135 of the door 123. This embedding creates a lamination of door layers and cables. The FIG. 11 illustration is essentially the same for either embodiment. The remainder of the structure is essentially identical between these two embodiments, whether the cables are attached directly to the door or the cables are embedded into the inner surface of the door.

Another embodiment based on the FIG. 11 illustration, covering either cable connection method, is to extend the axial height of the interior and exterior bollards 137 and 138 and add a second series of cables 126. The increased height of bollards 137 and 138 results in having enough area and spacing for the addition of three more posts 125 and two more struts 131. Although this increase in axial height of the bollards is illustrated as a doubling in terms of the height, number of cables 126, number of posts 125, and the number of struts 131, the increase could be tripled or quadrupled. Increasing the height of the bollards and the number of cables 126 and posts 125 means that as the point of initial vehicle impact shifts up axially, there is a cable or series of cables to hook onto the corresponding post for functioning as the security barrier.

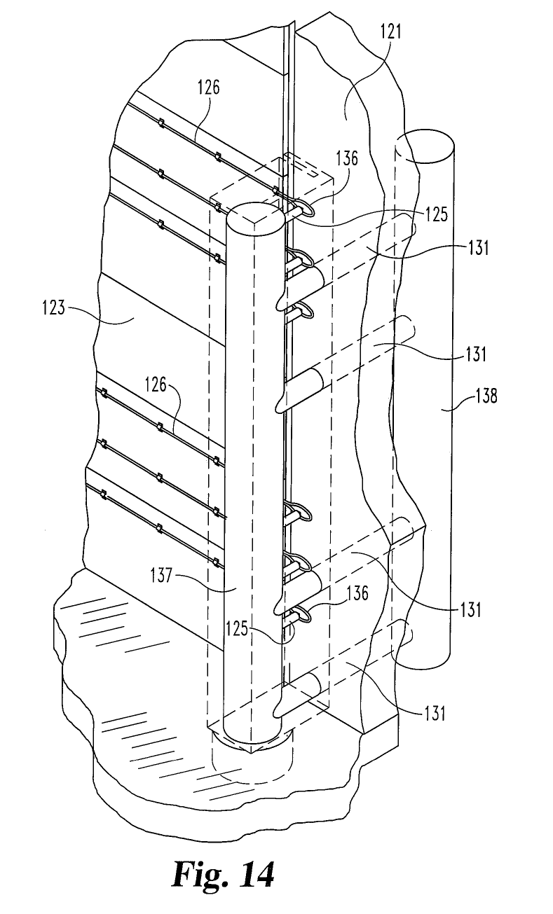

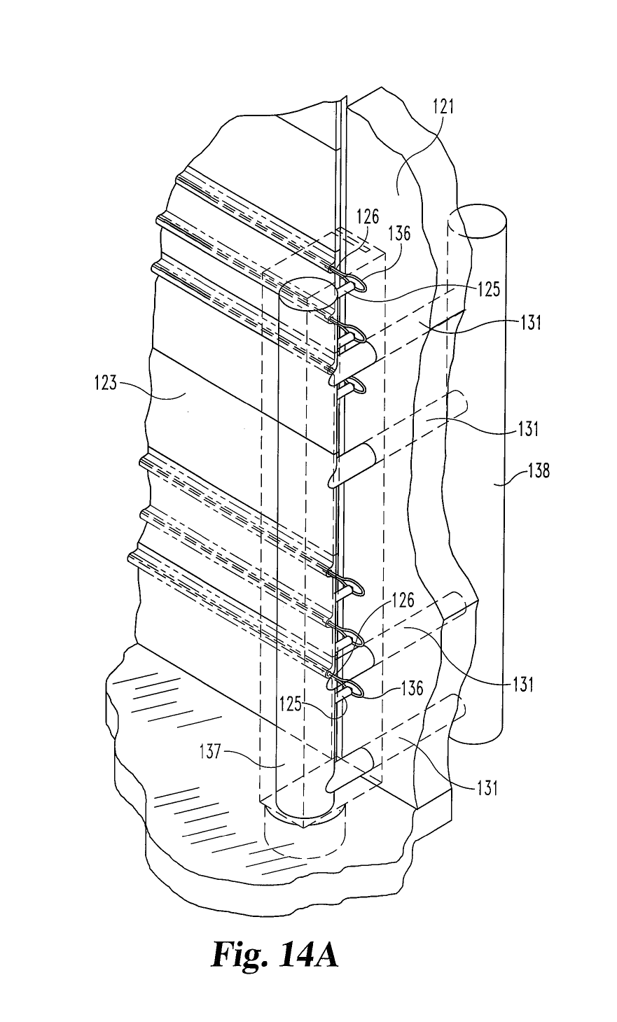

A further option is to provide a series of three cables 126 for each panel of the overhead door 123. Regardless of the number of cables 126 and the number of posts 125, there is preferably a one-to-one correspondence. Even if every loop end is not hooked onto its corresponding and cooperating post, those that are hooked on, due to impact of a vehicle, allows the apparatus to function in its intended manner. The non-engaged cable loops would simply remain as initially configured. In the FIG. 14A embodiment, the cables 126 are embedded within the door 123 rather than being attached to the door.

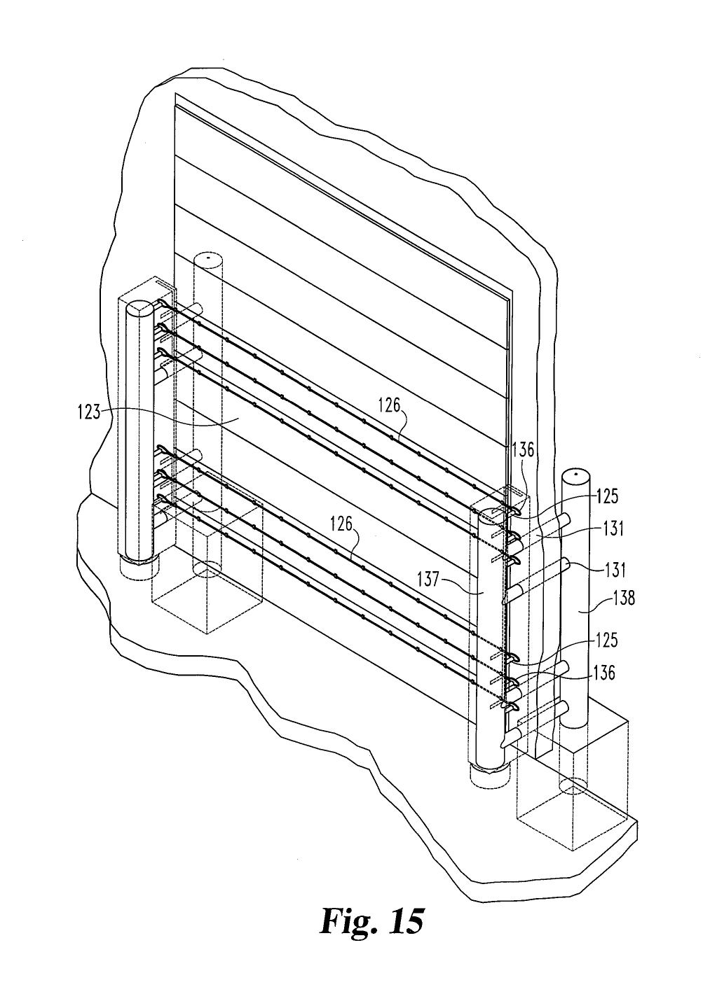

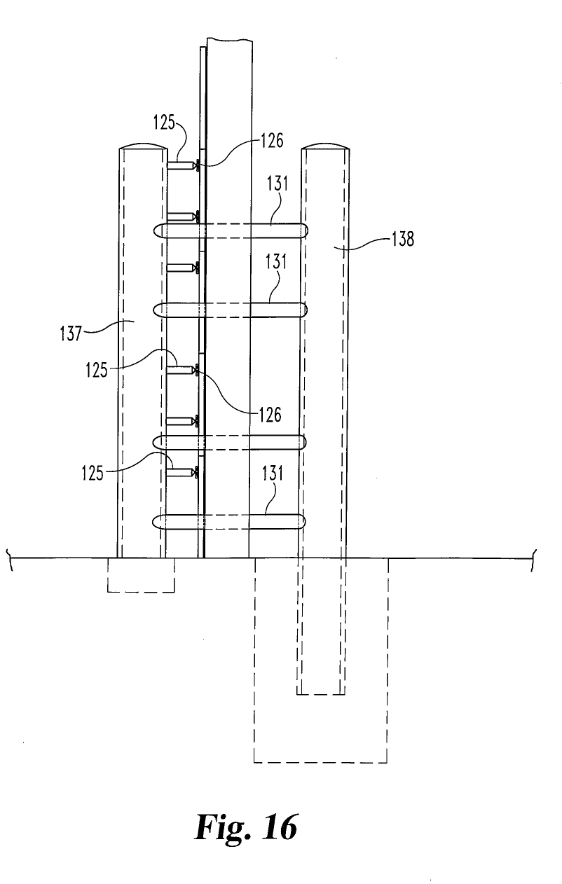

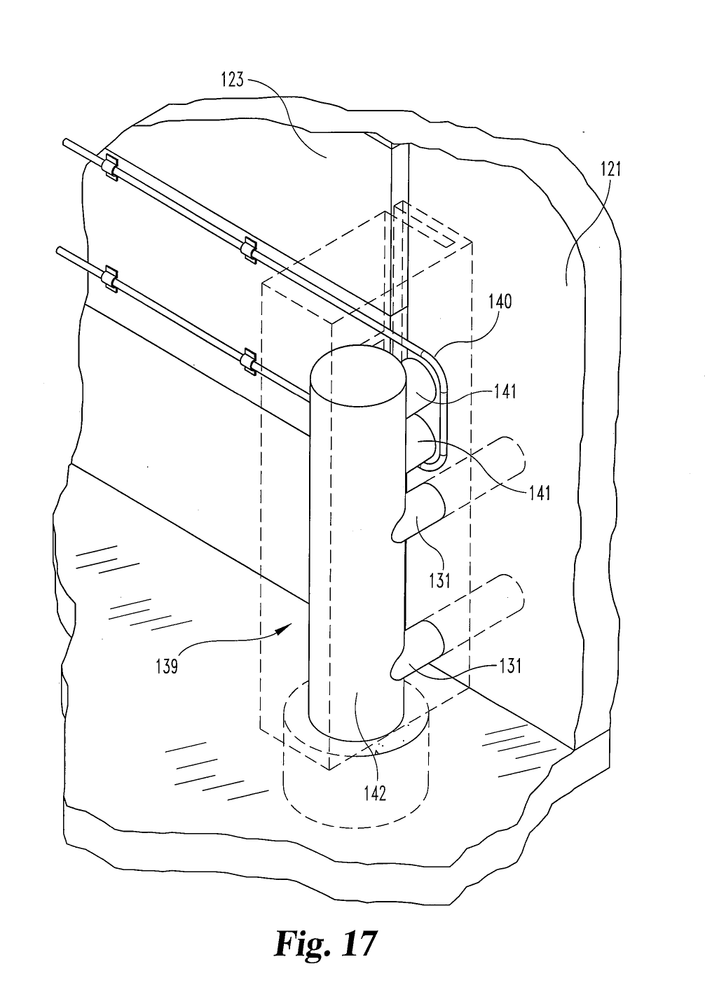

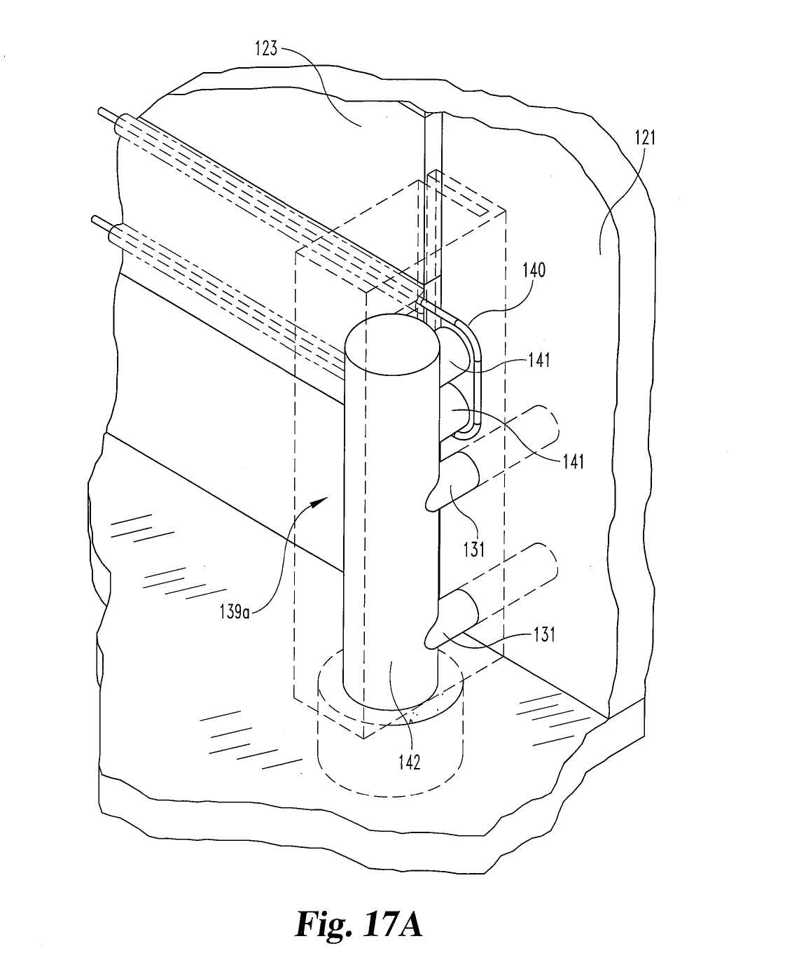

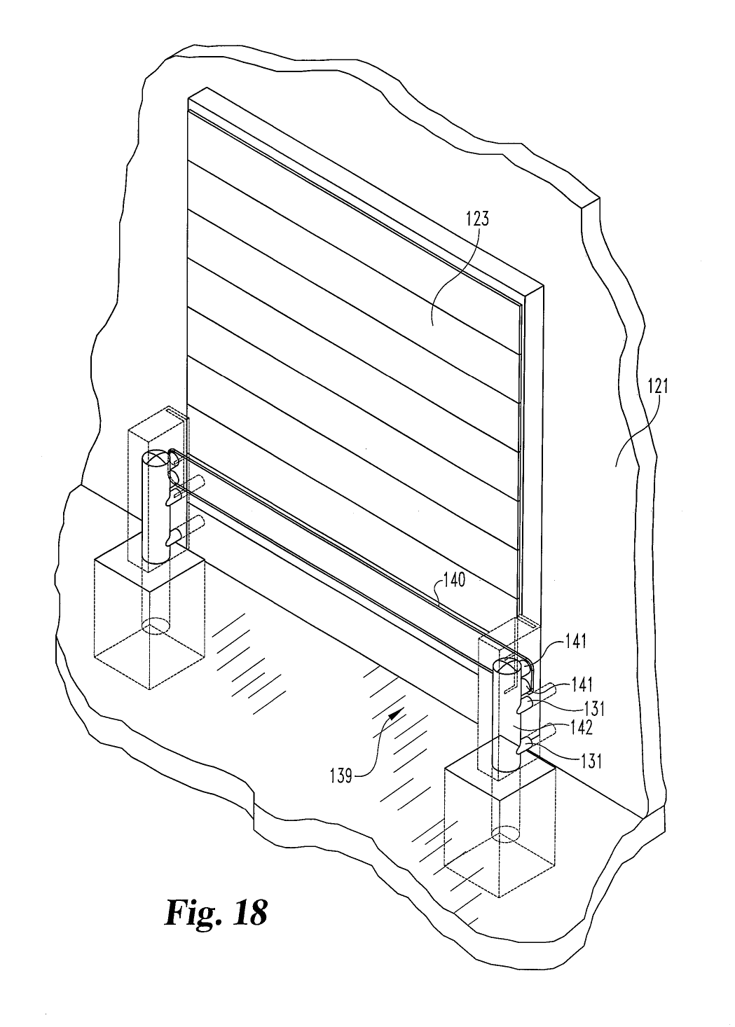

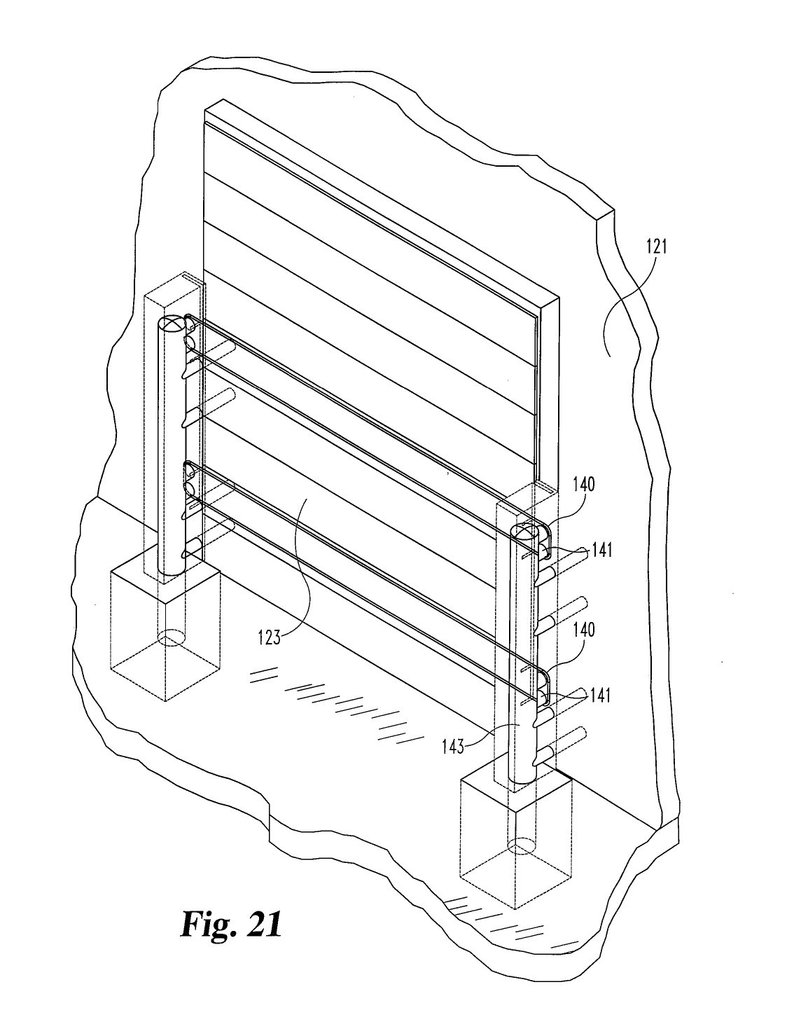

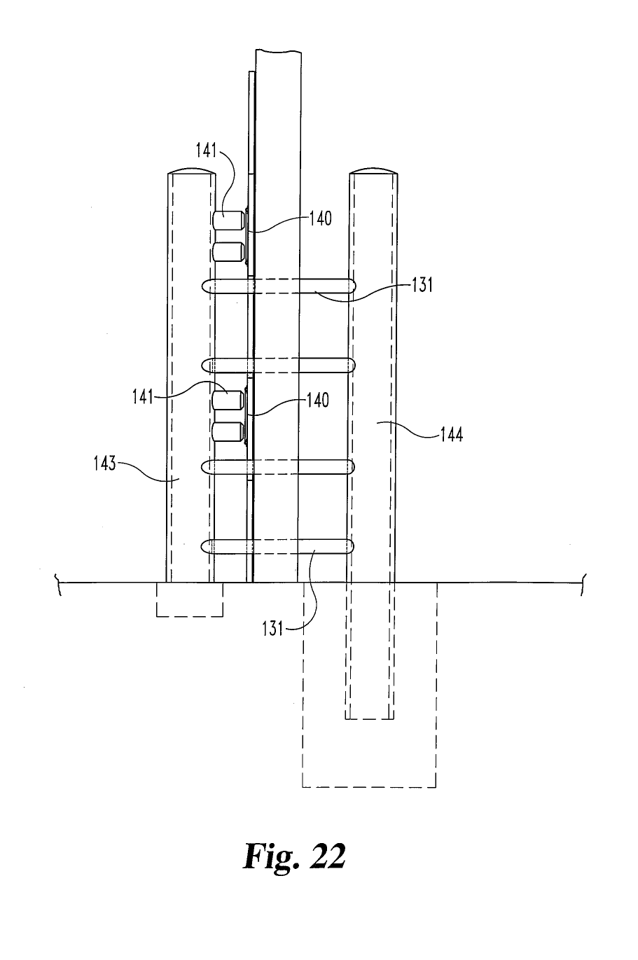

Referring now to FIGS. 17-22, further variations to the cable structure of FIGS. 11-16 are illustrated. More specifically the group of three cables 126 and three cooperating posts 125 of each cable grouping of the earlier apparatus 120 is replaced in apparatus 139 by a single continuous loop cable 140 and two, spaced-apart, larger posts 141. These are the only changes to the prior embodiment. All of the remaining structural portions of the apparatus 139, including the support structures are the same as before. This means that with inward deflection of the door due to impact from the exterior, the closed loop ends of cable 140 move onto posts 141. The changes in structure, as noted, are limited to the cables and posts. However, the addition of posts 141 as part of bollard 142 changes the reference numbering of that component. Apparatus 139a is constructed and arranged with cable 140 embedded into door 123.

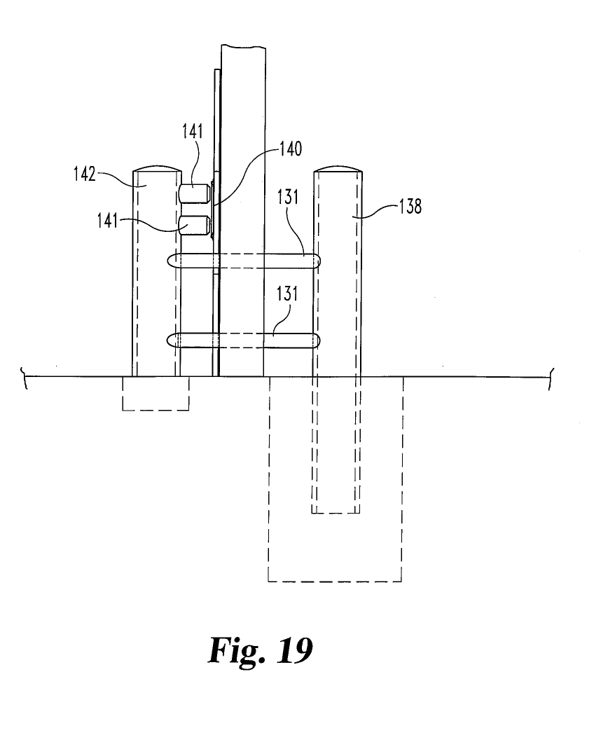

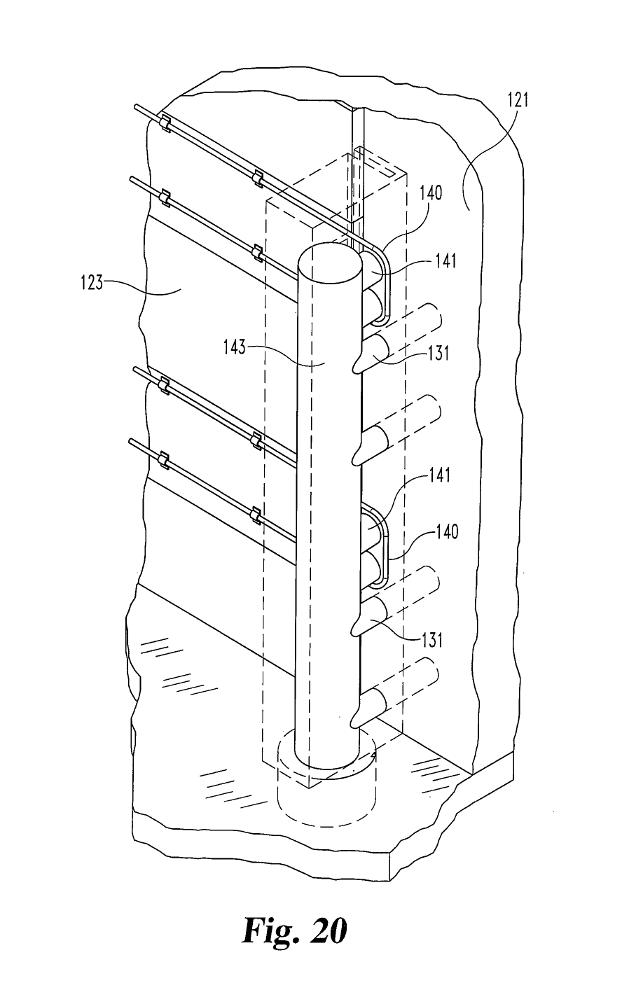

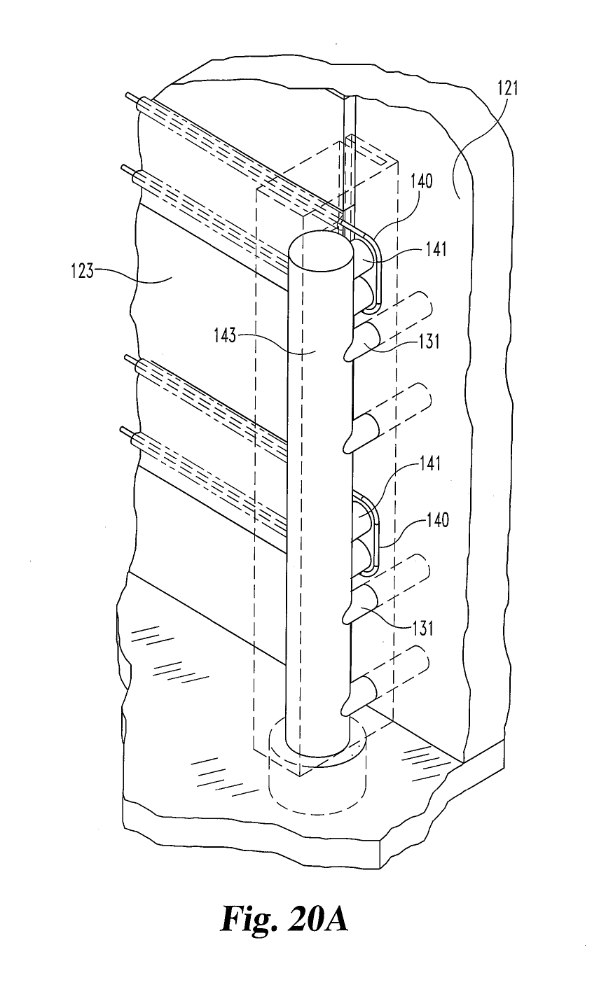

In this regard, multiple continuous loop cable and post combinations can be added by increasing the axial height of the interior and exterior bollards 142 and 138. Whether increasing the height and the numbers for a second cable arrangement or for a larger number of cable arrangements, the embodiments of FIGS. 20-22 are identical in all other respects to the arrangements of FIGS. 17-19. This includes either directly attaching the continuous loop cable 140 to the door or practicing the alternative embodiment of actually embedding the cable 140 directly into the door. Bollards 143 and 144 are of a double axial height and there is a second set of posts 141, cable 140, and struts 131.

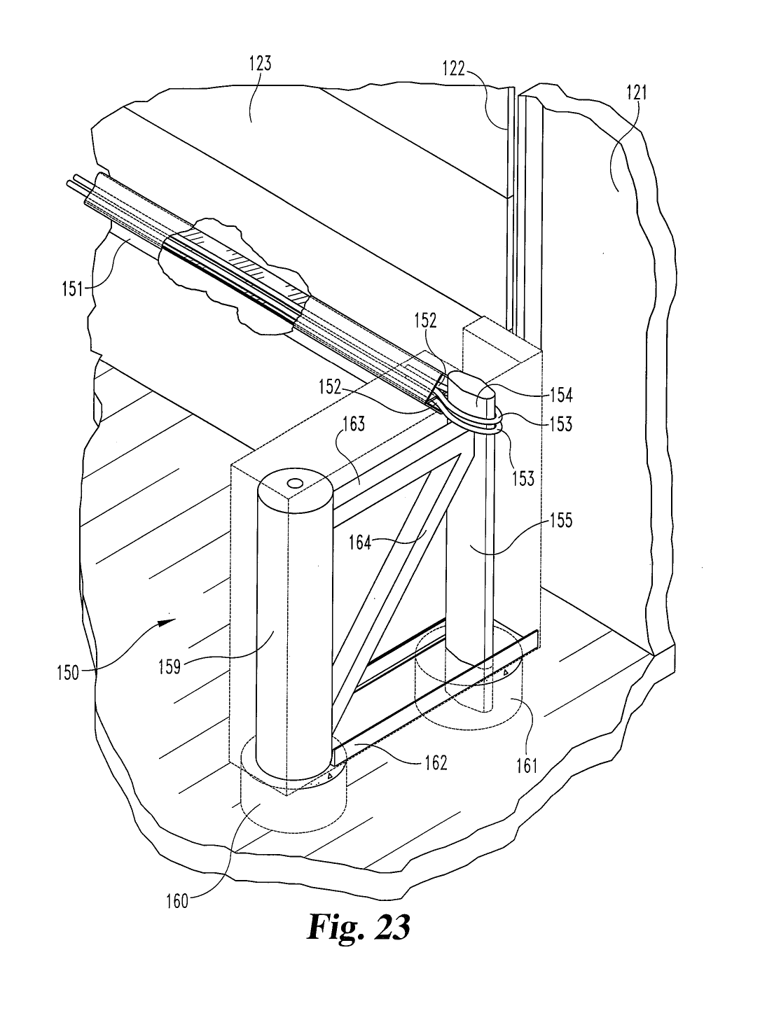

Referring now to FIGS. 23-28, another apparatus 150 embodiment is illustrated. The structure wall 121, opening 122, and door 123 are essentially the same as previously illustrated. The barrier portion includes a combination of a sleeve or beam 151 and cable 152 with a cable loop 153 at each end. The cable body is received by the beam 151. In the at-rest condition with the door closed, the cable loops 153 are hooked onto an upright cable post 154 of the support structure 155.

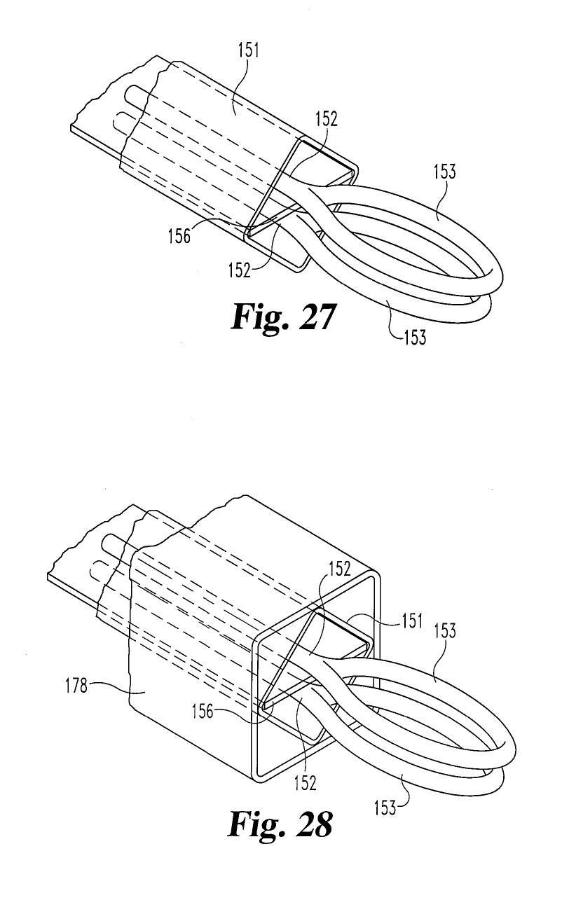

As for the manner of connecting or arranging the beam 151 and cable 152 combination to the door 123, essentially all of the options previously illustrated and disclosed can be used. The beam 151 can be directly attached to the surface of the door as one option. As another option, adjustable brackets, similar to those of FIGS. 5 and 6, can be used to lift the beam 151 and cable 152 combination and this lifts or unhooks the loops 153 up off of the cable posts 154. The details of the beam 151 and cable 152 combination is illustrated in FIG. 27. Cable 152 is a stranded wire rope in one embodiment and, in an alternative embodiment, is a composite or synthetic material. The beam 152 is an elongated member with a reinforcing and dividing plate 156 located in the center and extending between opposite corners. The lateral cross sectional shape of beam 152 is substantially square. The cable 152 is able to be threaded through either half on either side of the dividing plate 156. In an alternate embodiment, a double cable 152 is used. Each cable 152 includes its own connecting loop 153 at each end of each cable. Both of the loops at each end of the cable pair are aligned and hooked together over the exposed upper end of upright cable post 154. These variations are all illustrated in the group of figures for this alternative embodiment. In principal, this embodiment functions in a manner similar to the prior cable embodiment, except here the cable loops 153 are already hooked over the free end of each upright cable post 154 when the door 123 is closed. This arrangement does not rely on movement of the cables in order to get the cable loops 153 hooked onto the support post 154.

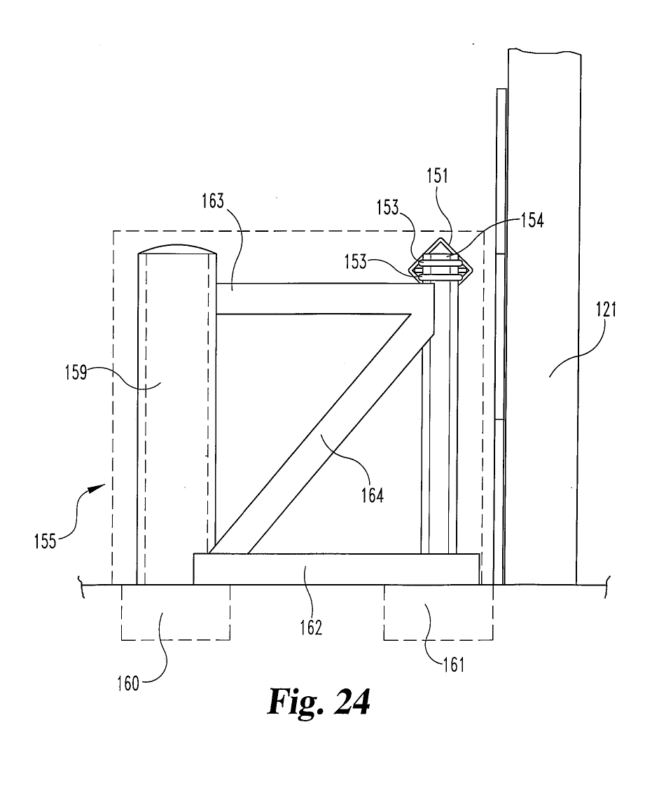

With continued reference to FIGS. 23 and 24, the details of support structure 155 are illustrated. Support structure 155 includes the upright cable post 154 that is constructed and arranged as an energy transfer member, a main (interior) bollard 159 that is concrete filled, a poured concrete footing 160 for bollard 159, a poured concrete footing 161 (interior) for the upright cable post 154, an anchor plate 162, a horizontal strut 163, and a diagonal brace 164. All of these components are rigidly and securely joined in the manner illustrated in order to provide holding securement for the dual or twin cables 152 that are encased by beam 151 between the opposite cable end loops 153. The same structure would be applicable if only a single cable 152 is used.

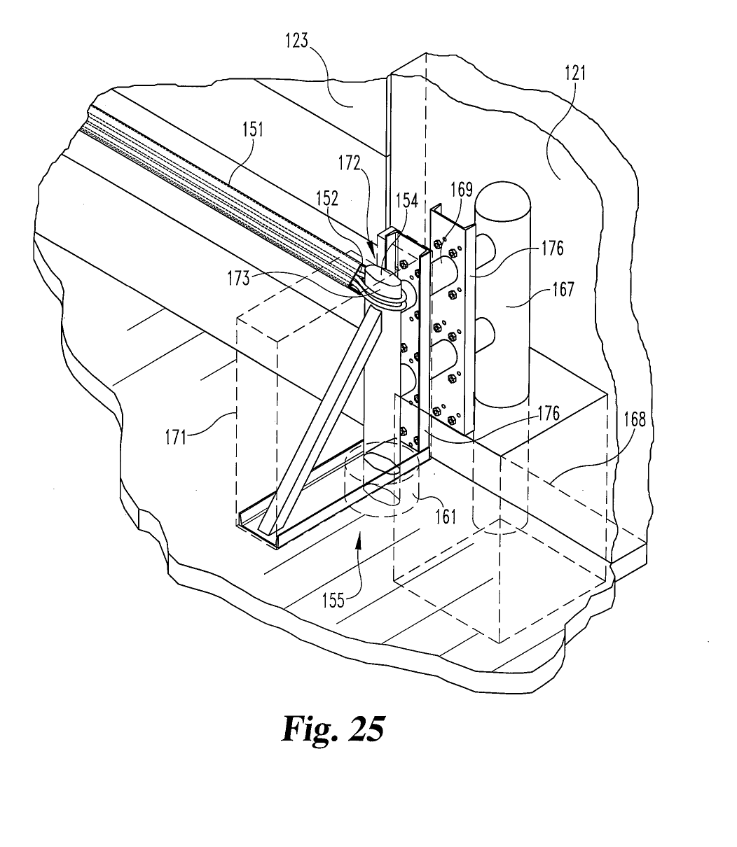

The exterior of the structure includes an exterior bollard and a cooperating concrete footing, similar to what has been described and illustrated for the other embodiments. The exterior bollard and footing are not shown in FIGS. 23 and 24, only for drawing clarity, since the focus is on other structural portions. An exterior bollard 167 and a cooperating concrete footing 168 are illustrated in the embodiments of FIG. 25 that do not use an interior bollard and footing. Also enclosed in this overall structural support arrangement are two, generally cylindrical and generally horizontal struts 169 that extend through the wall 170 of the structure. One end of each strut 169 is rigidly and securely anchored into exterior bollard 167. The opposite end of each strut 169 is rigidly and securely either anchored into or attached to the upright cable post 154. A covering cabinet 171 (in broken line form) can be used to cover the majority of support structure 155 for protection from inadvertent damage and for aesthetic reasons. Cabinet 171 is slotted or notched out at location 172 for clearance around the upper end 173 of cable post 154. It is upper end 173 that receives cable loops 153 and the clearance slot is needed so that the loops 153 are able to be lifted off of end 173 as the door is raised.

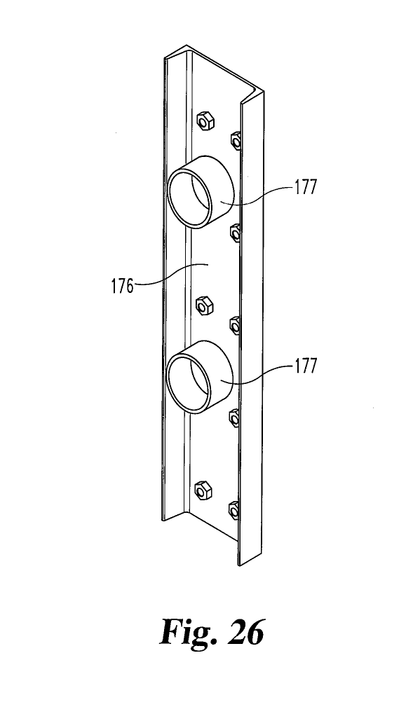

With continued reference to FIGS. 25 and 26, another option for support structure 155 is illustrated. In addition to what has already been illustrated for apparatus 150, and in particular for support structure 155, a pair of anchor plates 176 can be used. These two anchor plates have a generally U-shaped cross section for rigidity and stiffening and are tightly bolted together, actually clamping or sandwiching the wall 123. These anchor plates would preferably also be anchored to the corresponding footing 161 on the interior and 168 on the exterior. An alternate anchor plate 176a construction is a weldment with a pair of generally cylindrical sleeve members 177 for receiving struts 169 and thereby adding additional strength to those struts. Regardless of whether or not the sleeve members are used, each anchor plate 176 and 176a defines a pair of clearance holes for receiving the horizontal struts 169. The clearance holes are used in the FIG. 25 embodiment and the sleeve members 177 are shown in the FIG. 26 anchor plate.

Referring now to FIG. 28, a further variation or option for the beam 151 is illustrated. As previously described, beam 151 has a generally square lateral cross sectional shape with the reinforcing and dividing plate 156 extending from one interior corner to the opposite interior corner. One cable 152 extends through beam 151 on one side of the dividing plate 156 and the other cable 152 extends through beam 151 on the opposite side of the dividing plate 156. Each end of each cable 152 includes a cable loop 153 and the two loops at each end of beam 151 are hooked over the upper end 173 of the upright cable post 154 and the same assembly and connection occurs on the opposite side of the door where, for a single opening, another support structure 155 is located. If side-by-side openings are present, then the support structure in the middle with have the dual or tandem configuration similar to that illustrated in FIG. 7 so as to gain some fabrication efficiencies in terms of the bollards, footings, and further structural support.

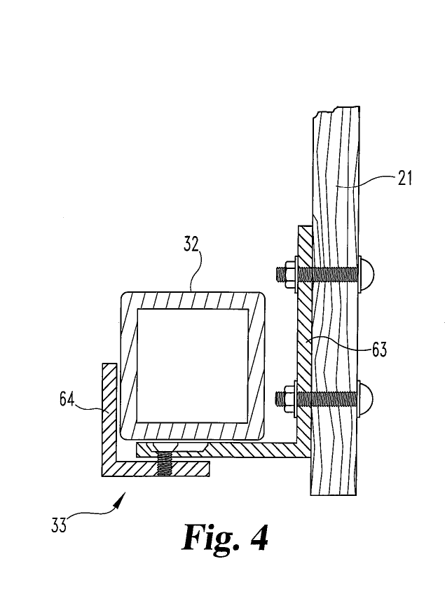

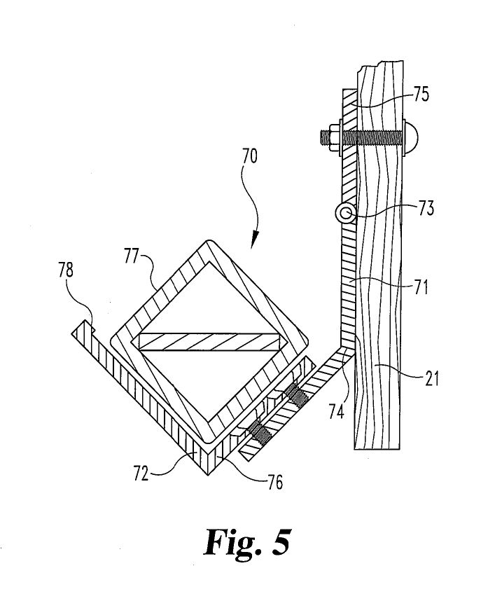

As for the further variation represented by FIG. 28, the beam 151 and pair of cables 152 are further encased in an outer casing beam 178 that has a lateral cross sectional shape that is generally square. The square shapes of the two beams are turned forty-five degrees relative to each other such that the corners of the inner beam 151 are centered on the walls of the outer beam 178. If the outer beam is used and if it maintains its orientation relative to the door, then that could dictate the shape and orientation of the lifting brackets, if lifting brackets are used. If the outer beam 178 is rigidly attached to the door, then lifting brackets would not be required. FIGS. 5 and 6 illustrate a lifting bracket design and construction when the beam is rotated for a “corner down” orientation. When it is a “flat down”, as in FIG. 28 for beam 178, the lifting bracket construction would be similar to the FIG. 4 construction.

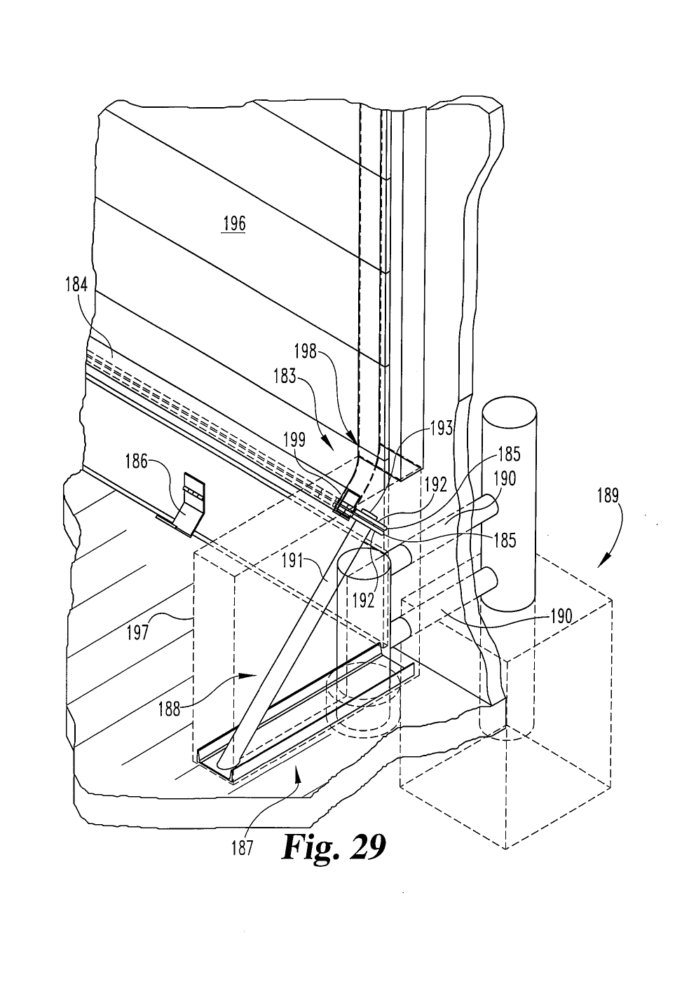

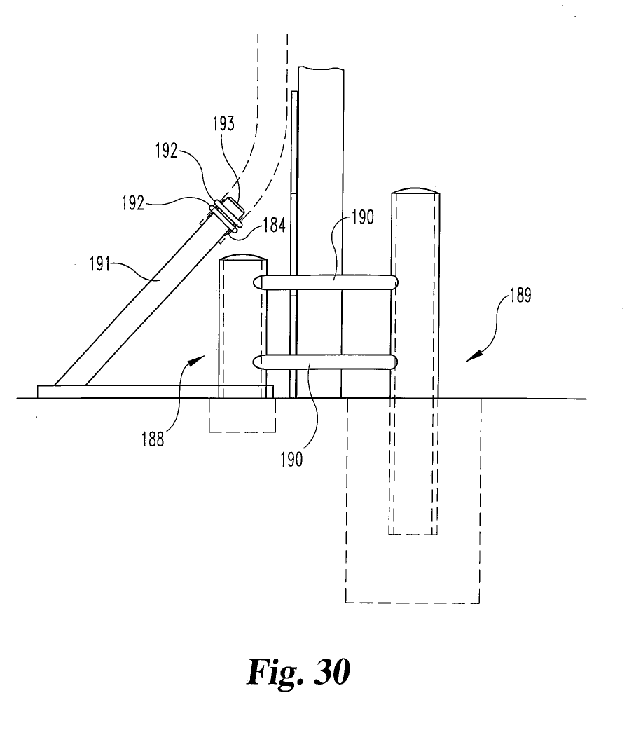

Referring now to FIGS. 29 and 30, a further variation to the prior embodiment is illustrated. The arrangement 183 includes a beam 184, a pair of cables 185, two lifting brackets 186 (only one shown), and a support structure 187. The support structure 187 includes an interior portion 188 and an exterior portion 189. The interior portion and exterior portion are joined by the generally cylindrical and generally horizontal struts 190. The construction and arrangement of these various components is essentially the same as the corresponding components of the prior embodiment. One difference between this embodiment (arrangement 183) and the prior embodiment is that the upright cable post 191 for receiving the cable loops 192 on upper end 193 is set at an incline rather than being substantially vertical. In the prior embodiment, upright cable post 154 was generally vertical and in addition there are minor variations in the overall structure and layout of the overall support structure, as between these two embodiments. In the embodiment of FIGS. 29 and 30, the lifting or raising of the door 196 causes the brackets 186 to raise the beam and pull the cable loops 192 off of the exposed upper end 193. This same overall structure and arrangement is positioned on the other side of the door 196 on the interior of the structure.

The angled or inclined orientation of portion 191 results in an angled initial movement of the cable loops 192 and thus of beam 184. Accordingly, the cabinet 197 (in broken line form) is notched or slotted at location 198 with an angled clearance shape that both receives the end 199 of beam 184, but also helps guide the lifting motion of beam 184 out of its captured position as the door 196 is raised.

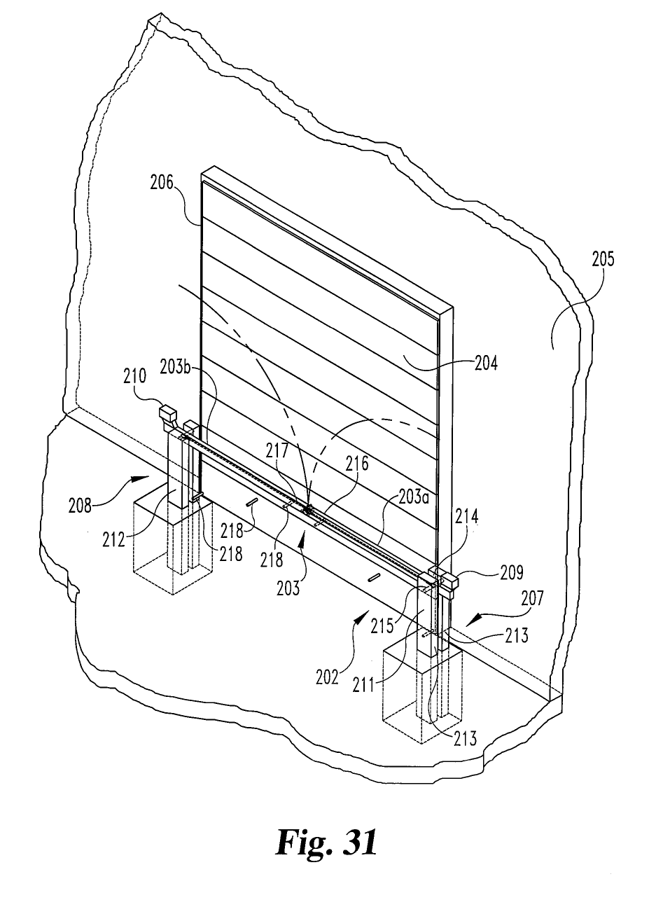

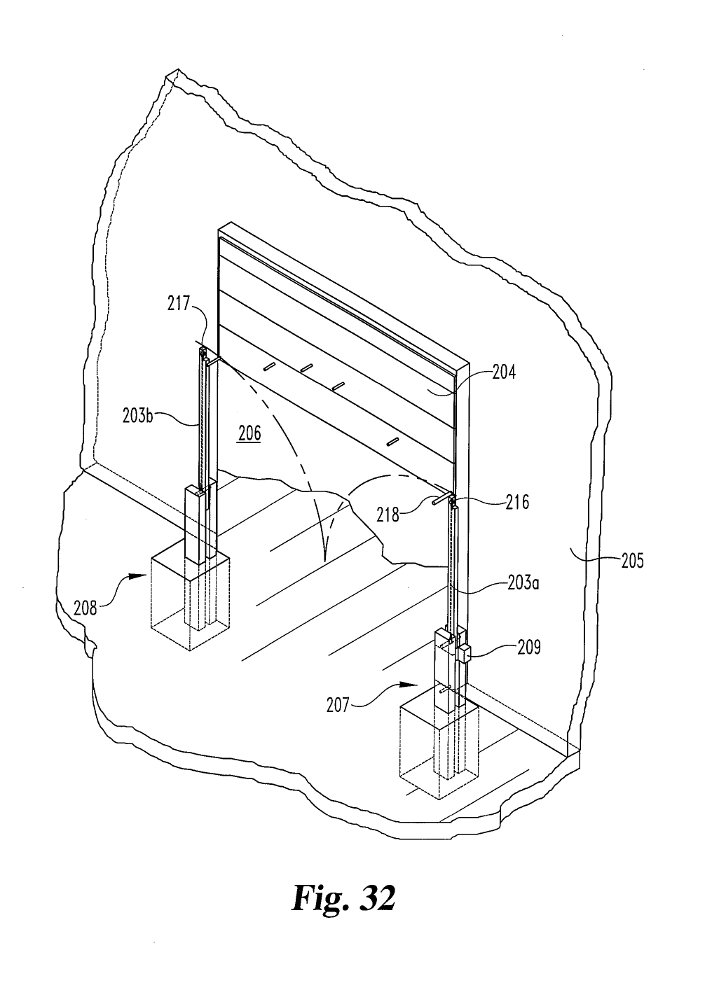

Referring now to FIGS. 31-33, another embodiment is illustrated. Arrangement 202 is intended to disclose, as an alternative, the use of a beam 203 that is in two sections 203a and 203b that are counterweighted at their captured ends and connected together at the approximate midpoint of the door 204. The structure, the structural wall 205, and the defined opening 206 are essentially the same as what has been illustrated and described in the prior embodiments. Further, support structures 207 and 208 are intended to be similarly constructed and arranged to the other support structures disclosed and illustrated herein, in terms of the bollards, the footings, the braces, the struts, etc. These structural portions are not included in FIGS. 31 and 32 for drawing simplicity, since the focus of this embodiment is on the two-part beam 203, the counterweights 209 and 210, and the manner in which the two beam sections are joined in the middle. It will also be noted that the counterweights 209 and 210 are at the hinged ends of each beam section 203a and 203b.

The upright portions 211 and 212 of the corresponding support structures 207 and 208, respectively, are constructed and arranged with a pair of spaced-apart posts 213 with an upper clearance slot 214. Pivot pin 215 extends through each post 213 and the received end of the corresponding beam section. This construction allows each beam section 203a and 203b to pivot upwardly and outwardly so as to not block any portion of the opening 206 when the door 204 is raised.

The connection of ends 216 and 217 of the beam sections 203a and 203b, respectively, is at the approximate midpoint or centerline of the opening so that the pivoting and lifting action of beach section performs in essentially the identical manner. Lift pins 218 are securely anchored into door 204 and perform the task of pivoting and lifting the two beam sections. Pins positioned closer to the center of the door will act first. However, as the beam sections 203a and 203b pivot, they move outwardly away from the center of the door 204 and opening 206. Pins positioned farther out toward the edge of the opening can then take over on the pivoting and lifting task. As the moment arm of the beam section in the direction of the opening becomes shorter, the counterweight has a more significant effect or contribution in easing the lifting action of the corresponding beam section. With the door in the raised position, and the opening exposed, the beam sections are lifted out of a blocking orientation, having been raised to a location that is just short of vertical. The beam sections are held in this position by the lowermost and outermost pins 218. As the door is lowered and the pins 218 move in a downward direction, the beam sections are acted on by gravity and follow the door, until returning to their blocking orientation extending across the closed door.

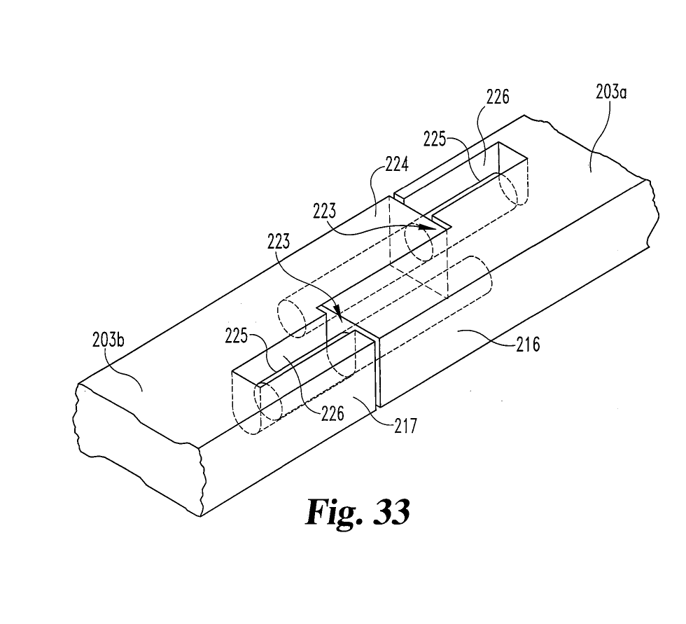

In terms of the overall strength of beam 203, the direction of vehicle impact is most likely going to be generally perpendicular to the surface of the door. The transmitted impact force against beam 203 is thus generally horizontal. That is the direction to be reinforced with regard to the connection of the two beam sections at the midpoint of the door. Beam section movement that begins in the vertical direction (i.e., the pivoting and lifting movement) can be essentially unrestrained. The corresponding structure for this center joint connecting together the inner ends of each beam section is illustrated in FIG. 33. As illustrated, each beam end 216 and 217 is constructed and arranged with a notched offset 223 and an extension portion 224. The extension portion 224 of one beam section fits into the clearance defined by offset 223 in the other beam section, and vice versa. A high strength pin 225 is anchored into the end of each extension and is received by a matching pin trough 226 in the other beam section. This construction becomes extremely strong when pushed horizontally, but still allows the beam sections to freely pivot upwardly and outwardly.

While the preferred embodiment of the invention has been illustrated and described in the drawings and foregoing description, the same is to be considered as illustrative and not restrictive in character, it being understood that all changes and modifications that come within the spirit of the invention are desired to be protected.

1. In combination:
a movable overhead door constructed and arranged for closing a structure opening; and
a crash barrier apparatus for use with said movable overhead door comprising:
a first support anchored to a first base on one side of said structure opening, said first support including a first post;
a second support anchored to a second base on another side of said structure opening, said second support including a second post; and
a cable joined to said movable overhead door and extending across said structure opening, said cable including a first end loop and a second end loop, said first end loop being generally aligned with said first post and said second end loop being generally aligned with said second post, wherein upon inward impact deflection of said movable overhead door, said first end loop becomes hooked onto said first post and said second end loop becomes hooked onto said second post.

2. The combination of claim 1 wherein two additional cables are joined to said movable overhead door and wherein said first and second supports each including second and third posts.

3. The combination of claim 2 wherein said two additional cables each include a pair of opposite end loops that are generally aligned with said second and third posts, respectively.

4. The combination of claim 1 which further includes a third support anchored to a base portion that is exterior to said structure, said third support being connected to said first support by at least one strut that extends through a wall portion of said structure.

5. The combination of claim 4 which further includes a fourth support anchored to a base portion that is exterior to said structure, said fourth support being connected to said second support by at least one strut that extends through a wall portion of said structure.

6. The combination of claim 1 wherein the joining of said cable to said movable overhead door is by means of a direct attachment of the cable to a surface of the movable overhead door.

7. The combination of claim 1 wherein the joining of said cable to said movable overhead door is by embedding at least a portion of said cable into the movable overhead door in the form of a lamination.

8. In combination:
a movable overhead door constructed and arranged for closing a structure opening; and
a crash barrier apparatus for use with said movable overhead door comprising:
a first support anchored to a first base on one side of said structure opening, said first support including a first post;
a second support anchored to a second base on another side of said structure opening, said second support including a second post; and
a continuous loop cable joined to said movable overhead door and extending across said structure opening, said cable having a first closed end generally aligned with said first post and a second closed end generally aligned with said second post, wherein upon inward impact deflection of said movable overhead door said first closed end becomes hooked onto said first post and said second closed end becomes hooked onto said second post.

9. The combination of claim 8 which further includes a third support anchored to a base portion that is exterior to said structure, said third support being connected to said first support by at least one strut that extends through a wall portion of said structure.

10. The combination of claim 8 which further includes a fourth support anchored to a base portion that is exterior to said structure, said fourth support being connected to said second support by at least one strut that extends through a wall portion of said structure.

11. The combination of claim 8 wherein the joining of said continuous loop cable to said movable overhead door is by means of a direct attachment of the cable to a surface of the movable overhead door.

12. The combination of claim 8 wherein the joining of said continuous loop cable to said movable overhead door is by embedding a portion of said continuous loop cable into the movable overhead door in the form of a lamination.
